(19) United States
(12) Patent Application Publication
(10) Pub. No.: US 2024/0204200 A1
(43) Pub. Date: Jun. 20, 2024

(54) ANODES VIA INTERFACIAL BONDING, METHODS OF MAKING SAME, AND USES THEREOF

(71) Applicant: Cornell University, Ithaca, NY (US)

(72) Inventors: Lynden A. Archer, Ithaca, NY (US); Jingxu Zheng, Shenzhen (CN)

(21) Appl. No.: 18/550,622

(22) PCT Filed: Mar. 15, 2022
(86) PCT No.: PCT/US22/20430

§ 371 Date: Sep. 14, 2023

Related U.S. Application Data
(60) Provisional application No. 63/161,140, filed on Mar. 15, 2021.

(51) Int. Cl. H01M 4/66; H01M 4/02; H01M 4/04; H01M 10/05; H01M 10/42

(52) U.S. Cl. CPC H01M 4/663; H01M 4/0404; H01M 10/05; H01M 10/4207; H01M 2004/021; H01M 2004/027; H01M 2010/4292

(57) ABSTRACT

Anodes and anode materials, methods of making anodes and anode materials, and devices. The anode and anode materials comprise an electrically conducting three-dimensional (3-D) matrix, for example, an electrically conducting 3-D carbon matrix or a metal foam, comprising a plurality of chemical bonding groups disposed on a surface of the electrically conducting 3-D matrix or metal foam. The chemical bonding groups can form chemical bond(s) with an electrochemically-deposited electrochemically active metal. The electrochemically-deposited electrochemically active metal can have desirable propert(ies), such as, for example, no observable discontinuities, isolated (orphaned) deposits, or both. An anode or anode material may be formed by functionalizing an electrically conducting 3-D matrix, which may be functionalized. A functionalized electrically conducting 3-D matrix may be formed in a device. A device, such as, for example,. a battery, a supercapacitor, a fuel cell, an electrolyzer, or an electrolytic cell, comprises one or more anode(s) or anode material(s).

### CROSS-REFERENCE TO RELATED APPLICATIONS

This application claims the benefit of U.S. Provisional Patent Application No. 63/161,140, filed Mar. 15, 2021, the contents of the above-identified application are hereby fully incorporated herein by reference in their entirety.

### STATEMENT REGARDING FEDERALLY SPONSORED RESEARCH AND DEVELOPMENT

This invention was made with government support under grant no. DE-SC0012673 awarded by the Department of Energy. The government has certain rights in the invention.

### BACKGROUND OF THE DISCLOSURE

Creating conformal metal coatings through electrochemical methods is important in multiple fields, including semiconductor manufacturing, energy storage, metal plating, etc. Although the governing chemistry is in principle simple- solvated metal cations in a typically liquid electrolyte capture electrons from an electrically conductive substrate, and are thereby reduced into solid metallic form, e.g., Mⁿ⁺ (sol.)+ne⁻→M(s), the control over metal electrodeposition morphology remains challenging. The search for fundamental solutions has recently re-emerged as an area of scientific and technological interest because of the role stable electrodeposition of metals in closed electrochemical cells play in the stability and safety of rechargeable batteries that utilize metal anodes, e.g., Al, Li, Zn, etc., for achieving higher energy and low cost storage of electrical energy.

Aluminum is the third most abundant element and most abundant metal in the earth's crust. Electrochemical cells using metallic Al as the negative electrode are of interest for their potential low cost, intrinsic safety and sustainability. Presently such cells are considered impractical because the reversibility of the metal anode is poor and the amount of charge stored is miniscule, both in comparison to what is theoretically possible with Al and with reference to state-of-the art Li-ion battery chemistries.

The working principle of such electrochemical cells is as follows: reversible plating and stripping of metal at the anode enables reversible storage and release of electrical energy. In practice, however, repeated formation and dissolution of the metallic phase is confounded by multiple problems that result in porous, non-planar deposition morphology. A number of mechanisms have been proposed to explain these observations. The list includes intrinsic crystal anisotropy, uneven solid-electrolyte interphase driving heterogeneous growth, concentration of electric field lines at “hot spots” for growth, and mass transport limited growth. Porous metal deposits created in one plating cycle also have a strong propensity to only partially dissolve in the next, forming the so-called “dead”/“orphaned” metals. Over repeated cycling, the accumulated metal deposits bridge the inter-electrode space to short-circuit the cell. All of these processes are obviously fatal for stable long-term operation of an electrochemical cell, but ohmic heat generated by shorting poses added safety concerns associated with thermal runaway.

In theory, metal anodes that take advantage of micro/nanopatterned conductive substrates that guarantee full access to electron and ion transport pathways throughout the plating and stripping processes can surmount all of these challenges. In conventional battery configurations, ion transport occurs via interfacial contact between solid metal deposits and liquid electrolyte, meaning that control of the electrolyte volume and interface chemistry are sufficient to ensure full ionic access. In contrast, electron transport relies solely on physical, solid-solid contact between metal deposits and a conductive substrate. Earlier work has shown that while electrodeposition of metals such as Cu in patterned trenches for integrated circuits and Li & Na in three-dimensional metal or carbon foams does constrain the size of the electrodeposits, the transport length I. and therefore t are broadly distributed, as the metal is free to deposit in coarse, non-planar morphologies.

### SUMMARY OF THE DISCLOSURE

In various examples, an anode material comprises: one or more electrically conducting three-dimensional (3-D) matrix(es), and a plurality of chemical bonding groups, where each of the plurality of chemical bonding groups are chemically bonded to a surface (such as, for example, an exterior surface, which may be a surface of a void space, if present, or the like) of an electrically conducting 3-D matrix. At least a portion of the surface(s) of the electrically conducting three-dimensional (3-D) matrix comprise chemical bonding groups disposed thereon. In various examples, the electrically conducting 3-D matrix is chosen from electrically conducting 3-D carbon matrixes, metal foams, and the like. In various examples, the electrically conducting 3-D carbon matrix(s) is/are chosen from carbon, carbon fabrics, carbon cloths, graphene aerogels, carbon nanotubes, vapor grown carbon fibers, activated carbon fibers, and the like, oxygen enriched derivatives thereof, and any combination thereof. In various examples, the electrically conducting three-dimensional (3-D) matrix comprises a plurality of porous regions, which may be at least partially continuous and/or may comprise one or more or all dimensions of 100 nm to 200 microns. In various examples, the porous regions comprise 30% or more of the total volume of the electrically conducting 3-D matrix. In various examples, the chemical bonding groups are chosen from halide groups, hydroxyl groups, carboxyl/carboxylate groups, sulfo groups, phosphonate groups, alkenyl groups, alkynyl groups, and the like, and any combination thereof. In various examples, at least a portion of the chemical bonding groups are bound to a surface (such as, for example, an exterior surface, which may be a surface of a void space, if present, or the like) of electrically conducting 3-D matrix via a linking group, where the linking group may comprise a metal (such as, for example, —O-M-, where M is a metal chosen from aluminum, zinc, lithium, sodium, calcium, magnesium, and the like, and any combination thereof). In various examples, at least a portion of the chemical bonding groups are provided by a material disposed on at least a portion of a surface (such as, for example, an exterior surface, which may be a surface of a void space, if present, or the like) of the electrically conducting 3-D matrix, where the material comprises the at least a portion of the chemical bonding groups. In various examples, the material is chosen from graphene, carbon nanotubes, ketjen black carbon, vapor grown carbon fibers, pyrolyzed carbon fibers, oxygen-enriched derivatives thereof, and the like, and any combination thereof. In various examples, the chemical bonding groups are disposed on at least 25% of the exterior surfaces (which may include void surface(s), if present) (which may not include the surface of the electrically conducting 3-D matrix on which material(s), if present, are disposed) of the electrically conducting 3-D matrix (which may be a functionalized electrically conducting 3-D matrix). In various examples, the number density of the chemical bonding groups is 0.01/nm² to 10/nm². In various examples, the electrically conducting 3-D matrix has a conductivity of 1 to 10⁸ S/m. In various examples, the electrically conducting 3-D matrix is disposed on a metal.

In various examples, an anode comprises one or more anode material(s) of the present disclosure (e.g., anode material(s) each comprising an electrically conducting three-dimensional (3-D) matrix(es), and a plurality of chemical bonding groups, where each of the plurality of chemical bonding groups are chemically bonded to a surface (such as, for example, an exterior surface, which may be a surface of a void space, if present, or the like) of an electrically conducting 3-D matrix). In various examples, the electrically conducting three-dimensional (3-D) matrix(es) is/are independently chosen from electrically conducting three-dimensional (3-D) carbon matrix(es), metal foams, and the like). In various examples, the anode further comprises an electrochemically active metal (such as, for example, a layer of an electrochemically active metal disposed on at least a portion or all of one or more surface(s) (such as, for example, exterior surface(s), which may be surface(s) of a void space, if present, or the like) of the electrically conducting 3-D matrix(es) of the anode material(s)). In various examples, the electrochemically active metal is chosen from aluminum, zinc, lithium, sodium, calcium, magnesium, and the like, and any combination thereof. In various examples, the layer of the electrochemically active metal has a thickness of 10 nm to 1 mm. In various examples, the number density of the chemical bonds between the electrically conducting 3-D matrix and layer of the electrochemically active metal is from 0.01/nm² to 10/nm², the layer of the electrochemically active metal is continuous over 50% or greater of one or more surface(s) of the electrically conducting 3-D matrix, or both. In various examples, there are no observable discontinuities in the layer of the electrochemically active metal over 50% or greater (or all) of the one or more surface(s) of the electrically conducting 3-D matrix (e.g., the one or more surface(s) of the electrically conducting 3-D matrix on which the material is disposed), the layer of the electrochemically active metal does not exhibit an isolated electrochemically active metal deposit or an isolated electrochemically active metal, or both. In various examples, the layer of electrochemically active metal is chemically bonded to the electrically conducting 3-D matrix(es) via a plurality of chemical bonds (such as, for example, covalent bonds, coordinate covalent bonds, ionic bonds, or the like, or any combination thereof. In various examples, the layer of electrochemically active metal is formed from reaction of a chemical bonding group with an electrochemically active metal, electrochemically active metal atom(s), or electrochemically active metal atom cluster(s), or any combination thereof. In various examples, the anode is a reversible anode.

In various examples, a method of making an electrode material or an anode of the present disclosure (such as, for example, an anode material comprising an electrically conducting three-dimensional (3-D) matrix and a plurality of chemical bonding groups, where each of the plurality of chemical bonding groups are chemically bonded to a surface (such as, for example, an exterior surface, which may be a surface of a void space, if present, or the like) of the electrically conducting 3-D matrix, or a anode comprising the anode material(s)) comprises: i) functionalizing an electrically conducting 3-D matrix, or ii) providing an electrically conducting 3-D matrix comprising a plurality of first chemical bonding groups chemically bonded to a surface of the electrically conducting 3-D matrix, where each of the plurality of chemical bonding groups are chemically bonded to a surface of the electrically conducting 3-D matrix, and functionalizing the electrically conducting 3-D matrix comprising a plurality of first chemical bonding groups, with a material comprising a plurality of second chemical bonding groups, where the electrode material is formed. In various examples, the electrically conducting three-dimensional (3-D) matrix(es) is/are independently chosen from electrically conducting three-dimensional (3-D) carbon matrix(es), metal foams, and the like). In various examples, the functionalizing results in formation of a plurality of first functional groups and the first functional groups are subjected to conditions such that at least a portion of the first functional groups is reacted to form a plurality of second functional groups, wherein the second functional groups are chemical bonding groups. In various examples, the functionalizing comprises contacting the electrically conducting 3-D matrix with a composition that forms the chemical bonding groups. In various examples, the functionalizing comprises forming a graphene layer on at least a portion of an exterior surface (which may be a void space, if present) of the electrically conducting 3-D matrix. In various examples, the method further comprises electrochemically depositing a layer of an electrochemically active metal on at least a portion of a surface of the electrically conducting 3-D matrix comprising a plurality of chemical bonding groups. In various examples, the electrochemical deposition is carried out in a device.

In various examples, a device comprises one or more anode(s) of the present disclosure (such as, for example, anode(s) each comprising an electrically conducting three-dimensional (3-D) matrix and a plurality of chemical bonding groups, where each of the plurality of chemical bonding groups are chemically bonded to a surface of the electrically conducting 3-D matrix). In various examples, the device is an electrochemical device (such as, for example, a battery, a supercapacitor, a fuel cell, an electrolyzer, an electrolytic cell, or the like. In various examples, the device is a battery, and the battery is an ion-conducting battery (such as, for example, an aluminum-ion conducting battery, a zinc-ion conducting battery, a lithium-ion conducting battery, a sodium-ion conducting battery, a calcium-ion conducting battery, a magnesium-ion conducting battery, or the like. In various examples, the battery further comprises a cathode and/or one or more electrolyte(s) and/or one or more current collector(s) and/or one or more additional structural component(s) (such as, for example, bipolar plate(s), external packaging, electrical contact(s)/lead(s) to connect wire(s), and the like, and any combination thereof. In various examples, the battery comprises a plurality of cells (such as, for example, 1 to 500 cells), each cell comprising one or more anode(s), and optionally, one or more cathode(s), one or more electrolyte(s), one or more current collector(s), or any combination thereof. In various examples, the device is a battery and the battery exhibits one or more desirable propert(ies) (such as, for example, one or all of the following: an areal capacity of at least 0.5 mAh/cm²; a cycle life of at least 100 cycles; an areal capacity of at least 0.4 or at least 1 mAh/cm² at a charging rate of 40 mA/cm² for at least 100 cycles; or a coulombic efficiency of 98% or greater. In various examples, the device is configured such that the anode(s) is/are formed prior to the first bulk metal electrodeposition on the anode(s) during routine operation of the device.

### BRIEF DESCRIPTION OF THE FIGURES

For a fuller understanding of the nature and objects of the disclosure, reference should be made to the following detailed description taken in conjunction with the accompanying figures in the Examples.

FIGS. 1A-1C show metal-substrate bonding-induced regulation of electrodeposition. The figure illustrates how strong surface bonding between Al and a conductive fibrillar carbon substrate facilitates electronic transport and influences morphological evolution of the Al anode. (FIG. 1A) At the onset of electrodeposition, Al forms the interfacial Al—O—C chemical bonds with the surface of carbon fibers. (FIG. 1B)

Guided by the chemical bonding interaction, Al grows laterally forming a uniform, compact deposition layer comprised of nanoscale grains on carbon fibers. (FIG. 1C) After the available carbon surface is fully covered, the subsequent Al deposits form micro-sized particles embedded among the carbon fibers. L denotes the electron transport length.

FIGS. 2A-2H show the propensity of Al anodes to exhibit heterogeneous growth on conventional substrates. (FIG. 2A) Coulombic efficiency measured in Al plating/stripping reactions at a capacity of 3.2 mAh/cm². Notice that 2 layers of a glass fiber (GF) separator were needed to prevent shorting. (FIG. 2B) SEM analysis of Al electrodeposits formed on a planar steel foil electrode at 4 mA/cm² and for a capacity of 0.8 mAh/cm². (FIG. 2C) (FIG. 2D) Elemental maps for Al (FIG. 2C) and Fe (FIG. 2D) from EDS analysis of the electrode surface shown in (FIG. 2B). (FIG. 2E) Schematic diagram showing the failure mechanism of Al electrodes. Higher areal deposition capacity and accumulation of “dead” metal in the GF membrane over multiple plating-striping cycles result in proliferation of non-planar metal deposits in the interelectrode space. GF and SS stand for glass fiber separator and inert stainless steel electrode, respectively. (FIG. 2F) SEM image of Al electrodeposits formed on a non-planar nickel foam electrode at a rate of 4 mA/cm² and capacity 1.0 mAh/cm². (FIG. 2G) (FIG. 2H) elemental maps Al (FIG. 2G) and Ni (FIG. 2H) from EDS analysis of the electrode surface shown in (FIG. 2F).

FIGS. 3A-3H show the microstructure of Al metal deposits formed on a substrate with strong metal-substrate bonding. SEM analysis of Al deposit morphology at varying areal capacity: (FIG. 3A) 0.2, (FIG. 3C) 1, (FIG. 3D) 3, (FIG. 3E) 3, (FIG. 3F) 4 mAh/cm². The inset of (FIG. 3E) shows SEM and corresponding EDS mapping of a selected region in (FIG. 3E). (FIG. 3B) Particle size distribution at 0.2 mAh/cm² (avg=139 nm). (FIG. 3G) 2D-XRD pattern of Al deposits on carbon fibers; and (FIG. 3H) corresponding integrated XRD line scan for the material in (FIG. 3G).

FIG. 4 shows an XPS characterization of the metal-substrate interaction. C 1s (FIGS. 4A, 4D), Al 2p (FIGS. 4B, 4E), O 1s, and (FIGS. 4C, 4F) spectra of Al samples in carbon fiber electrodes: (FIG. 4A)˜(FIG. 4C) as-deposited state and (FIG. 4D)˜(FIG. 4F) sputtered state. The peaks corresponding to the Al-O-C bond are shaded by grey and indicated in the plots by the vertical black lines. Upon sputtering, surface materials are removed from the samples by the incident Ar ion beam. Peak assignments are tabulated in Table 3.

FIGS. 5A-5D show electrochemical cycling behavior of structured Al electrodes in galvanostatic plating/stripping experiments. Al plating/stripping efficiency measured at areal capacities of: (FIG. 5A) 0.8 (FIG. 5B) 3.2 and (FIG. 5C) 8 mAh/cm². (FIG. 5D) Voltage profiles measured during Al plating/stripping at a very high areal capacity of 8 mAh/cm². The current densities used for the respective measurements are: (FIG. 5A) 4 mA/cm²; and (FIG. 5B) & (FIG. 5C) 1.6 mA/cm².

FIGS. 6A-6D show ultrahigh current density plating/stripping of Al. SEM analysis of Al plated at a current density of 40 mA/cm²; (FIG. 6A) on stainless steel, 0.4 mAh/cm², and (FIG. 6B) on carbon fibers, 0.4 mAh/cm². (FIG. 6C) Voltage profile showing the Al∥stainless steel cells fail by short-circuiting by the 2^{nd} cycle, 0.4 mAh/cm². (FIG. 6D) Coulombic efficiency versus cycle index for Al plating/stripping process on carbon fibers with metal-substrate bonding (top 0.4 mAh/cm², bottom, 1 mAh/cm²).

FIGS. 7A-7D show electrochemical plating/stripping behavior of Al metal on nonplanar nickel foam substrate. (FIG. 7A) Coulombic efficiency obtained at 0.8 mAh, 4 mA/cm². Voltage profiles of Al plating/stripping: (FIG. 7B) 0.8 mAh, 4mA/cm²; (FIG. 7C) 3.2 mAh, 1.6 mAh/cm² and (FIG. 7D) 8.0 mAh, 1.6 mA/cm². The results mean that the improvement made by using a nonplanar, inert architecture is limited, particularly at practical capacities, i.e. 3.2 and 8 mAh/cm².

FIGS. 8A-8C show an XPS spectrum of interwoven carbon fibers. (FIG. 8A) Pristine, (FIG. 8B) after exposure to IL+AICI3 electrolyte, (FIG. 8C) after exposure to dimethyl carbonate as a negative control. Peak assignments: 284.8 eV (C—C, C—H), 286 eV (C—O), 287.5-288 eV (C═O, O—C—O), 289 eV (O═C—O). The intensities at 286 and 287.5˜288 eV suggest that the exposure to IL+AlCl₃ significantly increases the level of oxygen enrichment on carbon fibers.

FIGS. 9A-9O show SEM images and EDS mapping of Al deposition morphology obtained using a sequential, two-step protocol. In Step I, a small capacity (0.05 mAh/cm²) of Al is deposited at fixed overpotential, n values (e.g., η=0.05, 0.3, 1.0, 2.0, 3.0V); In Step II, a greater areal capacity (i.e. 0.45 mAh/cm²) of Al is galvanostatically deposited at a current density (i.e. 4 mA/cm²). SEM images of the Al deposition morphology obtained using this protocol, with the n value equal to (FIG. 9A) 0.05 V, (FIG. 9B) 0.3 V, (FIG. 9C) 1.0 V, (FIG. 9D) 2.0 V, and (FIG. 9E) 3.0 V. (FIG. 9F)˜(FIG. 9O) the corresponding EDS mapping results.

FIGS. 10A-10I show an XPS spectrum of Al electrodeposits on carbon fibers, stainless steel and nickel foam. XPS of Al deposited on (FIG. 10A)˜(FIG. 10C) carbon fibers, (FIG. 10D)˜(FIG. 10F) stainless steel, and (FIG. 10G)˜(FIG. 10I) Ni foam. (FIG. 10A) (FIG. 10D) (FIG. 10G) C 1s spectra; (FIG. 10B) (FIG. 10E) (FIG. 10H) O Is spectra; (FIG. 10C) (FIG. 10F) (FIG. 10I) Al 2p spectra. Upper panels and lower panels show spectra before and after Ar⁺ sputtering, respectively. After sputtering, the Al—O—C bonding was observed on samples where Al was deposited on carbon fibers. On other samples, no significant metal-substrate covalent bonding is observable.

FIGS. 11A-11B show a schematic diagram illustrating the ion/electron transport in metal stripping. (FIG. 11A) In the stripping process of porous metal deposits, the dissolution spans the whole surface of the non-planar deposit. Dissolution at the base causes detachment and fragmentation of non-planar metal deposits, and prohibit electron transport towards the detached fragments. This leads to the formation of “dead”/“orphaned” metal. (FIG. 11B) In the stripping process of regulated, compact metal deposits, electron transport is sustained. The electrochemical dissolution can only occur at the top interface. L denotes electron transport length scale of the stripping process.

FIGS. 12A-12B show plating/stripping behavior of Al metal on inert, planar stainless steel. Voltage profiles of Al plating/stripping: (FIG. 12A) 0.8 mAh, 4 mA/cm²; and (FIG. 12B) 8.0 mAh, 1.6 mAh/cm². The cells get shorted after a very limited cycling, i.e., less than 20 hours. The event of battery shorting is evidenced by the sudden voltage drop in plating/stripping as the metal penetrates the separator and physically bridges the two electrodes, resulting in a small cell resistance.

FIG. 13 shows plating/stripping behavior of Al metal on inert, planar stainless steel (2 layers of GF are used). The cross indicates the event of battery shorting, as evidenced by a sudden voltage drop and an endless charging process. In addition to the low Coulombic efficiency (CE) values and the rapid battery short (cycle #16), the slopy stripping voltage curve indicates the large and ever-growing resistance associated with the dissolution process of the Al metal deposits. This behavior is indicative of the non-planar nature of and the uncontrolled electron transport in the metal deposits.

FIGS. 14A-14B show anode capacity retention under certain plating/stripping CE conditions with a N:P ratio of (FIG. 14A) 1:1 and (FIG. 14B) 3:1. In the case of n:p=1:1 (also referred to as “anode free”), to achieve a capacity retention of 80% over 200 cycles, a 99.9% metal plating/stripping CE is required. In the case of n:p=3:1 (i.e. extra Al is prestored in the battery), a 99.5% CE is required to achieve an 80% capacity retention over 500 cycles.

FIGS. 15A-15D show microstructural characterization of Al growth in the presence of glass fiber separator. (FIG. 15A) SEM and (FIG. 15B)˜(FIG. 15D) corresponding EDS mapping. The substrate is stainless steel foil. The result shows that Al has a strong propensity for growing along the glass fibers, forming Al deposits closed attached to the glass fibers. Deposition capacity: 1 mAh/cm².

FIGS. 16A-16C show a cross-section microstructural characterization of Al growth in the presence of glass fiber separator. (FIG. 15A)˜(FIG. 15B) SEM images and (FIG. 15C) corresponding EDS mapping. The substrate is nickel foam. The result shows that Al has a strong tendency to grow into the glass fibers, as opposed to the nickel foam architecture. This observation is suggestive of a stronger bonding of the Al deposits with the glass fiber surface, compared with the Ni surface. Deposition condition: 1 mAh/cm² at 4 mA/cm².

FIGS. 17A-17B show SEM images of bare interwoven carbon fibers. The individual fibers have a round cross section with a diameter of 7.5 μm.

FIG. 18 shows a Raman spectrum of interwoven carbon fibers. The ID/IG ratio is 1.9:1, which indicates a high concentration of defects containing sp3 hybridized carbon.

FIGS. 19A-19H show EDS mapping results of Al deposition on carbon fiber. (FIG. 19A)˜(FIG. 19D) 0.2 mAh/cm², (FIG. 19E)˜(FIG. 19H) 1 mAh/cm². (FIG. 19A) (FIG. 19E) secondary electron images. (FIG. 19B) (FIG. 19F) aluminum mapping. (FIG. 19C) (FIG. 19G) carbon mapping. (FIG. 19D) (FIG. 19H) chlorine mapping.

FIGS. 20A-20C show a SEM characterization of the thickness and the back side of the Al deposition layer. To further investigate the microstructure of the Al deposition layer, the layer was mechanically broken during sample preparation. The SEM images show that the thickness of this coating is ˜160 nm, and the back side exhibit a compact morphology, mimicking the surface pattern of the carbon fiber.

FIGS. 21A-21C show additional SEM images of Al deposition on carbon fibers. The images confirm the morphological uniformity across a large area at multiple length scales.

FIGS. 22A-22B show SEM images of Al electrodeposits after thermal annealing at 60° C. for 12 hours on (FIG. 22A) stainless steel and (FIG. 22B) carbon fibers. Deposition capacity: 1 mAh/cm². The morphologies before and after the thermal annealing process show negligible difference. This means that surface diffusion is not the prominent factor in determining Al's electrodeposition morphology. The results are in support of the guidelines described herein that a strong metal-substrate bonding is able to ensure the initial uniform nucleation and growth.

FIGS. 23A-23B show a SEM characterization of Al deposition on carbon fibers at an areal capacity of 8 mAh/cm². As the deposition capacity increases, microscale Al deposits fill into the inter-fiber space.

FIGS. 24A-24B show a SEM characterization of Al deposition on carbon fibers coated by a passivating interphase. Deposition capacity: 0.2 mAh/cm². Preparation of the passivating coating: Electrochemical cells made of lithium∥carbon fibers were assembled.

The electrolyte was 1 M LiPF₆ in ethylene carbonate/dimethyl carbonate. The carbon fiber electrode was held as 20 mV versus Li⁺/Li for 1 hour. In this process, an SEI was formed owing to the decomposition of the electrolyte. Afterwards, the carbon fiber electrode was held at 1.5 V versus Li⁺/Li until the current drops to less than 10⁻⁷ mA/cm² to fully delithiate the material. Al electrodeposition was carried out on the carbon fibers prepared according to the procedure specified above.

FIGS. 25A-25E show a microstructural characterization of Al deposition morphology obtained at two representative n overpotentials. Areal capacity: 0.05 mAh/cm². (FIG. 25A) SEM and (FIG. 25B) EDS mapping of Al deposits obtained at η=0.3 V; (FIG. 25C) (FIG. 25E) SEM and (FIG. 25D) EDS mapping of Al deposits obtained at η=2 V. The results show that while the nucleation landscape obtained at η=2V is more uniform 0.3V, diffusion limit-induced (DLI) dendrites are already observable.

FIGS. 26A-26B show a SEM characterization of the stripping morphology of Al on carbon fibers. 0.8 mAh/cm² Al was deposited on carbon fibers using 4 mA/cm² and then stripped away. The results are consistent with the electrochemically measured plating/stripping CE, suggesting the full, reversibly Al plate/strip. In addition, no morphological damage of carbon fibers can be observed, meaning that the carbon fibers, as deposition substrate, is stable against the volume change during plating/stripping.

FIGS. 27A-27G show a full battery cycling performance of Al batteries at elevated areal capacities (#X is the cycle number). (FIG. 27A)˜(FIG. 27C) Full batteries (coin cells) constructed using Al foil as the anode and graphite as the cathode. (FIG. 27A) voltage profile of galvanostatic charge-discharge at 20 C. Capacity retention and Coulombic efficiency retention at (FIG. 27B) 20 C and (FIG. 27C) 80 C. (FIG. 27D)˜(FIG. 27G) “Anode-free” full batteries constructed using carbon fibers as the anode and graphite as the cathode. (FIG. 27D) voltage profile of galvanostatic charge-discharge at 20 C. Capacity retention and Coulombic efficiency retention at (FIG. 27E) 80 C (FIG. 27F) 60 C. Data shown in (FIG. 27A)˜(FIG. 27F) are obtained in coin cells. (FIG. 27G) Cycling performance of anode-free carbon cloth∥graphite pouch cell. Size ˜2.3 cm². Tantalum foils are used as the current collectors placed on the back side of both electrodes.

FIGS. 28A-28B show an enlarged carbon cloth∥graphite pouch cell without Ta current collector behind the carbon cloth electrode. (FIG. 28A) Capacity vs. cycle number and (FIG. 28B) corresponding voltage profiles for large format “anode free” carbon cloth vs. graphite pouch cells with 9 cm² electrode area. Cells were cycled at a current density of 0.4 mA cm⁻² (1C rate) between 0.4-2.4 V. A preliminary assessment was provided on assembling larger form factor pouch cells (˜9 cm²) without the Ta back current collector behind the carbon cloth. The observations suggest that the high conductivity metal foil current collector plays an important role in maintaining the uniform and fast electron transport from the external circuit to the carbon cloth electrode.

FIGS. 29A-29G show an extension to Zn plating/stripping on carbon frameworks (#X is the cycle number). (FIG. 29A) (FIG. 29B) SEM images of Zn plating/stripping on bare carbon fibers. (FIG. 29C) Voltage profiles of galvanostatic plating/stripping of Zn at 60 mA/cm² on bare carbon fibers. (FIG. 29D) (FIG. 29E) SEM of Zn plating/stripping on graphene coated carbon fibers. (FIG. 29F) Voltage profiles of galvanostatic plating/stripping of Zn at 60 mA/cm² on graphene coated carbon fibers. (FIG. 29G) Coulombic efficiency of Zn plating/stripping on carbon fibers with (grey) and without (black) graphene coating. The deposition was performed using linear sweep voltammetry: 20 mV/s, from 0 V to −0.2 V v.s. Zn²⁺/Zn. This group of results shows that the carbon fiber surface can be functionalized by a coating layer that enables stronger metal-substrate interaction.

FIGS. 30A-30F show an Al plating/stripping on carbon nanotube (CNT)-coated stainless steel substrate. Al plating/stripping voltage profiles on (FIG. 30A) (FIG. 30B) graphitized CNT coated stainless steel; (FIG. 30C) (FIG. 30D) carboxylic side group functionalized CNT coated stainless steel. (FIG. 30E) (FIG. 30F) Coulombic Efficiency of Al plating/stripping on carboxylic side group functionalized CNT. Current density: 1.6 mA/cm².

### DETAILED DESCRIPTION OF THE DISCLOSURE

Although claimed subject matter will be described in terms of certain examples, other examples, including examples that do not provide all of the benefits and features set forth herein, are also within the scope of this disclosure. Various structural, logical, and process step changes may be made without departing from the scope of the disclosure.

As used herein, unless otherwise indicated, “about”, “substantially”, or “the like”, when used in connection with a measurable variable (such as, for example, a parameter, an amount, a temporal duration, or the like) or a list of alternatives, is meant to encompass variations of and from the specified value including, but not limited to, those within experimental error (which can be determined by, e.g., a given data set, an art accepted standard, etc. and/or with, e.g., a given confidence interval (e.g. 90%, 95%, or more confidence interval from the mean), such as, for example, variations of +/−10% or less, +/−5% or less, +/−1% or less, and +/−0.1% or less of and from the specified value), insofar such variations in a variable and/or variations in the alternatives are appropriate to perform in the instant disclosure. As used herein, the term “about” may mean that the amount or value in question is the exact value or a value that provides equivalent results or effects as recited in the claims or taught herein. That is, it is understood that amounts, sizes, compositions, parameters, and other quantities and characteristics are not and need not be exact, but may be approximate and/or larger or smaller, as desired, reflecting tolerances, conversion factors, rounding off, measurement error, or the like, or other factors known to those of skill in the art such that equivalent results or effects are obtained. In general, an amount, size, composition, parameter, or other quantity or characteristic, or alternative is “about” or “the like,” whether or not expressly stated to be such. It is understood that where “about,” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5%, but also, unless otherwise stated, include individual values (e.g., 1%, 2%, 3%, and 4%) and the sub-ranges (e.g., 0.5% to 1.1%; 0.5% to 2.4%; 0.5% to 3.2%, and 0.5% to 4.4%, and other possible sub-ranges) within the indicated range. It is also understood (as presented above) that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent radicals and multivalent radicals, such as, for example, divalent radicals, trivalent radicals, and the like). Illustrative examples of groups include:

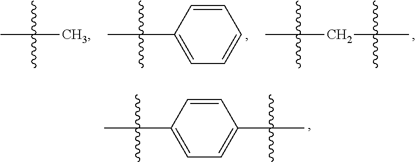

and the like.

As used herein, unless otherwise indicated, the term “alkenyl group” refers to branched or unbranched hydrocarbon groups comprising one or more C—C double bond(s). Examples of alkenyl groups include, but are not limited to, an ethenyl (vinyl) group, 1-propenyl groups, 2-propenyl (allyl) groups, 1-, 2-, and 3-butenyl groups, isopropenyl groups, and the like. In various examples, an alkenyl group is a C₂ to C₂₀ alkyenyl group, including all integer numbers of carbons and ranges of numbers of carbons therebetween (e.g., a C₂, C₃, C₄, C₅, C₆, 20 C₇, C₈, C₉, C₁₀, C₁₁, C₁₂, C₁₃, C₁₄, C₁₅, C₁₆, C₁₇, C₁₈, C₁₉, or C₂₀ alkenyl group). An alkenyl group may be unsubstituted or substituted with one or more substituent(s). Examples of substituents include, but are not limited to, halogens (—F, —Cl, —Br, and —I), aliphatic groups (e.g., alkyl groups, alkenyl groups, alkynyl groups, and the like), halogenated aliphatic groups (e.g., trifluoromethyl group and the like), cycloaliphatic groups, aryl groups, halogenated aryl groups, alkoxide groups, amine groups, nitro groups, carboxylate groups, carboxylic acid groups, ether groups, silyl ether groups, alcohol groups, and the like, and any combination thereof.

As used herein, unless otherwise indicated, the term “alkynyl group” refers to branched or unbranched hydrocarbon groups comprising one or more C—C triple bond(s).

Examples of alkynyl groups include, but are not limited to an ethyne group, 1- and 2-propyne groups, 1-, 2-, and 3-butyne groups, and the like. In various examples, an alkynyl group is a C₂ to C₂₀ alkynyl group, including all integer numbers of carbons and ranges of numbers of carbons therebetween (e.g., a a C₂, C₃, C₄, C₅, C₆, 20 C₇, C₈, C₉, C₁₀, C₁₁, C₁₂, C₁₃, C₁₄, C₁₅, C₁₆, C₁₇, C₁₈, C₁₉, or C₂₀ alkynyl group). An alkynyl group may be unsubstituted or substituted with one or more substituent(s). Examples of substituents include, but are not limited to, halogens (—F, —Cl, —Br, and —I), aliphatic groups (e.g., alkyl groups, alkenyl groups, alkynyl groups, and the like),), cycloaliphatic groups, halogenated aliphatic groups (e.g., trifluoromethyl group and the like), aryl groups, halogenated aryl groups, alkoxide groups, amine groups, nitro groups, carboxylate groups, carboxylic acid groups, ether groups, silyl ether groups, alcohol groups, and the like, and any combination thereof.

The present disclosure provides anodes and anode materials, and methods for forming anodes or anode materials. The present disclosure also provides devices comprising an anode and/or anode material, which may be formed using a composition or method of the present disclosure.

The present disclosure provides, inter alia, electrodes designed to promote desirable chemical bonding between metal deposits and an electron conducting substrate. In various examples, anodes or anode materials provide desirable control of Al electrodeposit morphology and provide desirable reversibility (99.6%˜99.8%). The reversibility is sustained over unusually long cycling times (greater than 3600 hours) for an Al anode and at areal capacities up to two orders of magnitude higher than previously reported values. Without intending to be bound by any particular theory, it is considered these traits result from elimination of fragile electron (e-) transport pathways and non-planar deposition of Al via specific metal-substrate chemical bonding. Using zinc metal anodes as another example, the generality of the concept was illustrated by creating highly reversible Zn anodes based on similar anode design.

In an aspect, the present disclosure provides anodes and anode materials. The anodes may be reversible anodes. The anode materials may be reversible anode materials.

Anodes and anode materials may be made by methods of the present disclosure. Non-limiting examples of anodes and anode materials are disclosed herein.

In various examples, a concept of the present disclosure is described as bonding between the substrate (S) (where S is an electrically conducting 3-D matrix) and a metal (M), which may be an electrochemically active metal, mediated by functional groups (e.g., S-oxygen-M, S-carboxylic group-M, S-sulfonate group-M, or the like, or any combination thereof). A substrate may comprise carbon (e.g., graphene, carbon nanotubes, carbon fibers, or the like, or any combination thereof). A metal may be any of the metals that are of interest as an anode material. Functional groups, which may be referred to in the alternative as chemical bonding groups (CBGs), may be halide groups, hydroxyl groups, carboxyl groups, sulfo groups, phosphonate groups, alkenyl groups (which may be a portion of a conjugated group), alkynyl groups (which may be a portion of a conjugated group), or, where applicable, deprotonated or at least partially deprotonated derivatives or analogs thereof, or the like, or any combination thereof.

In various examples, an anode material or an anode comprises an electrically conducting 3-D matrix, where at least a portion of an exterior surface of the electrically conducting 3-D matrix comprises a plurality of chemical bonding groups (CBGs) chemically bonded to at least a portion of one or more or all of one or more surface(s) of the electrically conducting 3-D matrix. In various examples, the anode material or anode is a reversible anode or reversible anode material. In various examples, the electrically conducting 3-D matrix is a non-planar electrically conducting 3-D matrix. In various examples, the electrically conducting 3-D matrix comprises (or defines) a plurality of porous regions (e.g., voids). In various examples, the chemical bonding groups are chemically bonded to at least a portion of one or more or all of one or more surface(s) (e.g., exterior surface(s), surface(s) of void region(s), if present, or the like, or any combination thereof) of the electrically conducting 3-D matrix. In various examples, the electrically conducting 3-D matrix is an electrically conducting 3-D carbon matrix or the like.

An electrode material may be disposed on a metal or metal alloy. In various examples, an electrode material is disposed on a metal or metal alloy (e.g., a metal substrate, a metal alloy, or the like), which may form an anode. In various examples, an anode comprises one or more anode material(s) disposed on at least a portion or all of one or more surface(s) of a metal or metal alloy. In various examples, the metal is planar or non-planar. In various examples, the metal is a current collector (e.g., a metal current collector, a metal alloy current collector, or the like). Non-limiting examples of current collectors are known in the art. In various examples, a metal or metal alloy is stainless steel, copper, aluminum, nickel, tantalum, molybdenum, or the like, or an alloy thereof.

An electrically conducting 3-D matrix can have various forms. Non-limiting examples of matrixes include carbon frameworks, metal frameworks (e.g., metal foams, such as for example, nickel foams, copper foams, and the like, and the like), and other frameworks formed from other conductive materials, and the like, and any combination thereof. Non-limiting examples of carbon frameworks include carbon fabrics, carbon cloths, graphene aerogels, carbon nanotubes, and the like, and any combination thereof.

In various examples, an electrically conducting 3-D matrix is an electrically conducting 3-D carbon matrix. An electrically conducting 3-D carbon matrix may comprise (or be) a carbon cloth or a carbon fabric, or the like. In various examples, a carbon cloth or carbon fabric comprises (or is) a single layer of carbon cloth or carbon fabric or multiple layers of a carbon cloth or carbon fabric. A cloth or carbon fabric may be woven or non-woven. A woven cloth or woven fabric may have a 3-D weave pattern. A non-woven cloth or non-woven fabric may be perforated.

In various examples, an electrically conducting 3-D carbon matrix comprises (or is) interconnected carbon fibers (CF) and forms Al—O—C bonding with Al electrodeposits. In various example, full batteries comprise an Al—CF anode and a graphite cathode.

An electrically conducting 3-D matrix e.g., electrically conducting 3-D carbon matrix or the like) may have various sizes. In an example, the smallest dimension (which may be a linear dimension) of the matrix is 10 microns or greater and/or the porosity of current collector is 20% or greater. The electrically conducting 3-D matrix e.g., electrically conducting 3-D carbon matrix or the like) may have at least one dimension (which may be a linear dimension) (e.g., a dimension (which may be a linear dimension) perpendicular to the longest dimension (which may be a linear dimension) of the electrically conducting 3-D matrix) of at least 10 microns.

An electrically conducting 3-D matrix (e.g., electrically conducting 3-D carbon matrix or the like) may comprise (or define) a plurality of porous regions (e.g., voids). The porous regions may comprise a plurality of pores (e.g., voids), a portion of which or all of which may be continuous (e.g., in fluid contact). In various examples, the porous regions are continuous such that two or more surfaces (which may two surfaces opposed to each other) of the matrix are in fluid contact. In various examples, the porous regions are continuous throughout the volume of the electrode, electrode material, catalyst, or catalyst material. The porous regions (e.g., voids) may be at least partially, substantially (which may be that a majority of the porous regions/voids) are continuous (e.g., in fluid contact or the like), or completely continuous (which may be that porous regions/voids are continuous (e.g., in fluid contact or the like)). The porous regions (e.g., voids) may, independently or all, have one or more dimension(s) or all dimensions (e.g., one or more linear dimension(s)) of 100 nm to 200 microns, including all integer nm values and ranges therebetween. The porous regions (e.g., voids) may be 30% or more, 50%, 90% or more, or 95% or more of the total volume of the electrically conducting 3-D matrix.

An electrically conducting 3-D matrix may have desirable electrical conductivity. In various examples, the electrically conducting 3-D matrix has a conductivity of 1 to 10⁸ S/m, including all integer S/m values and ranges therebetween.

A chemical bonding group can be any functional group that forms or reacts to form one or more chemical bond(s) to a metal (e.g., metal atoms and/or metal atom clusters, or the like) (e.g., electrochemically active metal atoms and/or electrochemically active metal atom clusters, or the like), which may be on (e.g., disposed on) the anode or the anode material. The chemical bonding groups may be a combination of two or more different chemical bonding group(s), where the different chemical bonding groups are different in terms of one or more compositional feature(s), one or more structural feature(s), or the like, or any combination thereof. Non-limiting examples of chemical bonding groups (which may be chemical bonding groups directly bound to an exterior surface of an electrically conducting 3-D matrix (e.g., an electrically conducting 3-D carbon matrix or the like)) include halide groups (e.g., —F, —Cl, —Br, and —I), hydroxyl groups (e.g., —OH), carboxyl/carboxylate groups (e.g. —C(O)OH/—C(O)O⁻ groups), sulfo groups (e.g., —S(O)₂O⁻ groups), phosphonate groups (e.g., —P(O)(O⁻)₂ groups), alkenyl groups (e.g., —C═C—, which may be a portion of a conjugated group), alkynyl groups (which may be a portion of a conjugated group), carboxylic groups, and the like, and any combination thereof.

A chemical bonding group may be bound to a surface of an electrically conducting 3-D matrix (e.g., an electrically conducting 3-D carbon matrix or the like) via a linking group. A linking group connects (e.g., via one or more covalent bond(s), ionic bond(s), or any combination thereof) a chemical bonding group to a surface of an electrically conducting 3-D matrix (e.g., an electrically conducting 3-D carbon matrix or the like). A linking group may comprise a metal (e.g., an electrochemically active metal), which may be the same or different than the metal (e.g., the electrochemically active metal) on (e.g., disposed on) the anode or the anode material). Non-limiting examples of linking groups include —O-M-CBG groups (where M is a metal, such as, for example, aluminum, zinc, lithium, sodium, calcium, magnesium, or the like, and CBG is a chemical bonding group), and the like and any combination thereof.

A chemical bonding group may be a portion of or all of a material, which may be a conducting material (e.g., a conducting carbon material or the like), disposed on (e.g., chemically bound to at least a portion of one or more or all of one or more surface(s) (e.g., exterior surface(s), surface(s) of void region(s), if present, or the like, or any combination thereof) of an electrically conducting 3-D matrix (e.g., an electrically conducting 3-D carbon matrix or the like). In the case where at least a portion of the chemical bonding groups are a portion of a material, the electrically conducting 3-D matrix (e.g., the electrically conducting 3-D carbon matrix or the like) may or may not have other chemical bonding groups disposed on at least a portion of or all of one or more other surface(s) (surface(s) on which the material is not disposed).

Non-limiting examples of chemical bonding groups that are a portion of or all of a material disposed (e.g., chemically bound) to a surface of the electrically conducting 3-D matrix (e.g., the electrically conducting 3-D carbon matrix or the like) include alkenyl, hydroxyl, carboxylic, sulfonate, phosphonate and so on groups of a graphene layer (e.g., a graphene monolayer, multilayer graphene, or the like), carbon nanotubes and derivatives or analogs thereof (e.g., oxygen-enriched carbon nanotubes and the like), ketjen black carbon, vapor grown carbon fibers, pyrolyzed carbon fibers, and derivatives or analogs thereof (e.g., oxygen-enriched derivatives or analogs thereof and the like), and the like, and any combination thereof. As a non-limiting illustrative example, an electrically conducting 3-D matrix (e.g., an electrically conducting 3-D carbon matrix or the like) comprises one or more material(s), such as, for example, one or more graphene layer(s) or the like) disposed on at least a portion of or all of one or more of the exterior surface(s) (which may include surface(s) of void space(s), if present) of the electrically conducting 3-D matrix (e.g., the electrically conducting 3-D carbon matrix or the like), where the chemical bonding groups are carbon-carbon double bonds (which may have delocalized pi-electrons) of the graphene layer.

At least a portion or all of the chemical bonding groups may be reactive chemical bonding groups. By “reactive chemical bonding groups” it is meant that these groups undergo a chemical reaction with at least a portion of a metal (e.g., metal atoms and/or metal atom clusters, or the like) (e.g., electrochemically active metal atoms and/or electrochemically active metal atom clusters, or the like), which may be on (e.g., disposed on) the anode or the anode material forming one or more chemical bond(s) (e.g., covalent bond(s), coordinate covalent bond(s) (which may be referred to as dative bonds or coordinate bonds), ionic bond(s), or the like, or any combination thereof) with the metal (e.g., the electrically conducting metal). As a non-limiting illustrative example, an electrically conducting 3-D matrix (e.g., an electrically conducting 3-D carbon matrix or the like) comprises a plurality of —Al—X (e.g., X is independently a halide group, a hydroxyl group, carboxyl group, sulfonate group, phosphonate group, or, where applicable, protonated or at least partially protonated analogs thereof, or the like.

In various examples, the chemical bonding groups may be disposed on at least 25%, at least 50%, at least 75% of the exterior surfaces of the electrically conducting 3-D matrix (e.g., the electrically conducting 3-D carbon matrix or the like). In various examples, the number density of the chemical bonding groups is 0.01/nm² to 10/nm², including all 0.005/nm² values and ranges therebetween.

An anode or anode material may comprise various electrochemically active metals. An electrochemically active metal may be disposed on a portion of or all of a surface or surfaces of the electrically conducting 3-D matrix (e.g., the electrically conducting 3-D carbon matrix or the like), which may include the porous region(s) (e.g., void space(s)). In various examples, the electrochemically active metal is an oxophilic metal. In various examples, the electrochemically active metal is aluminum, zinc, lithium, sodium, calcium, magnesium, or the like, or any combination thereof.

An anode or an anode material may comprise: an electrically conducting 3-D

matrix (which may be referred to a substrate) (which may comprise a plurality of porous regions (e.g., voids)); and optionally, a layer of an electrochemically active metal, which is chemically bonded to at least a portion or all of one or more surfaces of the electrically conducting 3-D matrix. The electrochemically active metal may be disposed one at least a portion of the exterior surface(s) and/or in at least a portion or all of the porous regions of the electrically conductive 3-D matrix. In various examples, the electrically conducting 3-D matrix is an electrically conducting 3-D carbon matrix or the like. In various examples, an electrically conducting 3-D matrix (e.g., an electrically conducting 3-D carbon matrix or the like) is a planar electrically conducting 3-D matrix (e.g., a planar electrically conducting 3-D carbon matrix or the like) or a non-planar electrically conducting 3-D matrix (e.g., a non-planar electrically conducting 3-D carbon matrix or the like). In various examples, at least a portion of or all of one or more surface(s) of the electrically conducting 3-D matrix (e.g., the electrically conducting 3-D carbon matrix or the like) forms interfacial chemical bonding with at least a portion of the layer of electrochemically active metal. The layer of electrochemically active metal may be uniform and/or continuous. The layer of electrochemically active metal may be planar or non-planar. In various examples, the layer of electrochemically active metal does not comprise any orphaned electrochemically active metal (which may be referred to as electrochemically active dead metal).

A layer of electrochemically active metal can have various thicknesses. In various examples, the layer of the electrochemically active metal has a thickness (which may be a dimension (which may be a linear dimension) perpendicular to a longest dimension (which may be a linear dimension) of the layer or a dimension (which may be a linear dimension) perpendicular to a surface of or a longitudinal axis of the electrically conducting 3-D matrix (e.g., the electrically conducting 3-D carbon matrix or the like) of 10 nm to 1 mm (e.g., 50 nm to 500 nm or 100 μm to 300 μm), including all 0.1 nm values and ranges therebetween.

Without intending to be bound by any particular theory, it is considered that chemical bonding groups form one or more chemical bond(s) with at least a portion of the electrochemically active metal (which may be electrochemically active metal atoms and/or electrochemically active metal atom clusters) on (e.g., disposed on) the anode or the anode material. The chemical bonds may be covalent bonds, coordinate covalent bonds (which may be referred to, in the alternative, as dative bonds or coordinate bonds), ionic bonds, or the like, or any combination thereof. A chemical bonding group may be directly bound to an exterior surface (which may be a void surface) of an electrically conducting 3-D matrix (e.g., electrically conducting 3-D carbon matrix or the like).

In various examples, the chemical bonds are chosen from —C—X-M bonds (wherein M is aluminum, zinc, lithium, sodium, calcium, magnesium, or the like, and/or X is O, CBG (or a group formed by reaction of a CBG with a metal, metal atom(s), or metal atom cluster(s)), or the like (e.g., electrochemically active metal, electrochemically active metal atom(s), an electrochemically active metal atom cluster(s), or the like)) (e.g., —C—O-M and the like).

An electrically conducting 3-D matrix (e.g., the electrically conducting 3-D carbon matrix or the like) can comprise various numbers of chemical bonds between the electrically conducting 3-D matrix (e.g., the electrically conducting 3-D carbon matrix or the like). In various examples, the number density of the chemical bonds between the electrically conducting 3-D matrix (e.g., the electrically conducting 3-D carbon matrix or the like) and layer of the electrochemically active metal is from 0.01/nm² to 10/nm², including all 0.005/nm² and ranges therebetween.

A layer of the electrochemically active metal may be continuous (e.g., continuous over 50% or greater, 60% or greater, 70% or greater, 80% or greater, 90% or greater, 95% or greater, or 100% of one or more surface(s) of the electrically conducting 3-D matrix (e.g., the electrically conducting 3-D carbon matrix or the like)). In various examples, there are no observable discontinuities in the layer of the electrochemically active metal over at 50% or greater, 60% or greater, 70% or greater, 80% or greater, 90% or greater, 95% or greater, or 100% of one or more surface(s) of the electrically conducting 3-D matrix (e.g., the electrically conducting 3-D carbon matrix or the like). Discontinuities can be observed by methods known in the art. In various examples, no discontinuity is observed by optical microscopy, electron microscopy, or both, over 50% or greater, 60% or greater, 70% or greater, 80% or greater, 90% or greater, 95% or greater, or 100% of one or more surface(s) of the electrically conducting 3-D carbon matrix.

A layer of the electrochemically active metal may not exhibit an isolated electrochemically active metal deposit or deposits (e.g., one or more electrochemically active metal deposit(s) not in contact with any other metal deposits). In various examples, an electrochemically active metal deposit has at least one linear dimension of 20 to 50 microns, including all 0.1 micron values and ranges therebetween. In various examples, the layer of the electrochemically active metal does not exhibit isolated a metal deposit or deposits over at 50% or greater, 60% or greater, 70% or greater, 80% or greater, 90% or greater, 95% or greater, or 100% of one or more surface(s) of the electrically conducting 3-D matrix (e.g., the electrically conducting 3-D carbon matrix or the like). In various examples, there are no observable isolated metal deposit or deposits in the layer of the electrochemically active metal over at 50% or greater, 60% or greater, 70% or greater, 80% or greater, 90% or greater, 95% or greater, or 100% of one or more surface(s) of the electrically conducting 3-D matrix (e.g., the electrically conducting 3-D carbon matrix or the like). An isolated electrochemically active metal deposit or metal deposits can be observed by methods known in the art. In various examples, no isolated electrochemically active metal deposit or metal deposits is observed by optical microscopy, electron microscopy, or both, over 50% or greater, 60% or greater, 70% or greater, 80% or greater, 90% or greater, 95% or greater, or 100% of one or more surface(s) of the electrically conducting 3-D matrix (e.g., the electrically conducting 3-D carbon matrix or the like).

An anode or anode material may be formed in situ. In various examples a device (such as, for example, a battery or the like) is configured such that the anode(s) and/or anode material(s) are formed (e.g., by a method of the present disclosure) prior to the first bulk electrochemically active metal electrodeposition on the anode(s) and/or anode material(s) during routine operation of the battery.

In an aspect, the present disclosure provides methods of forming anodes or anode materials. The methods may be used to form an anode or anode material of the present disclosure. In various examples, an anode and/or an anode material is/are made by a method of the present disclosure or the like. Non-limiting examples of methods are disclosed herein.

In various examples, a method of making an electrode or an electrode material comprises functionalizing contacting an electrically conducting 3-D matrix (e.g., an electrically conducting 3-D carbon matrix or the like), where a functionalized electrically conducting 3-D matrix (e.g., functionalized electrically conducting 3-D carbon matrix or the like) comprising a plurality chemical bonding groups (CBGs) disposed thereon (e.g., chemically bonded to a surface of the electrically conducting 3-D matrix (e.g., the electrically conducting 3-D carbon matrix or the like)) is formed or providing a functionalized electrically conducting 3-D matrix (e.g., functionalized electrically conducting 3-D carbon matrix or the like) comprising a plurality chemical bonding groups (CBGs) disposed thereon (e.g., chemically bonded to a surface of the electrically conducting 3-D matrix (e.g., the electrically conducting 3-D carbon matrix or the like)), which may be further functionalized.

A method may comprise functionalizing an electrically conducting 3-D matrix (e.g., an electrically conducting 3-D carbon matrix or the like). In various examples, the functionalizing comprises forming one or more chemical bonding group(s) on at least a portion or all of one or more or all of the surface(s) of an electrically conducting 3-D matrix (e.g., an electrically conducting 3-D carbon matrix or the like) (forming a functionalized electrically conducting 3-D matrix (e.g., a functionalized electrically conducting 3-D carbon matrix or the like)). In various examples, an electrically conducting 3-D matrix (e.g., an electrically conducting 3-D carbon matrix or the like) comprises one or more chemical bonding group(s) disposed on at least a portion or all of one or more or all of the surface(s) of the electrically conducting 3-D matrix (e.g., the electrically conducting 3-D carbon matrix or the like) is functionalized with one or more additional chemical bonding group(s) (e.g., with one or more chemical bonding group(s) and/or with one or more material comprising one or more chemical bonding group(s) disposed thereon). In various examples, an electrically conducting 3-D matrix (e.g., an electrically conducting 3-D carbon matrix or the like) (which may already be functionalized) is functionalized with two or more different chemical bonding group(s) (e.g., two or more different chemical bonding group(s), where the different chemical bonding groups are different in terms of one or more compositional feature(s), one or more structural feature(s), or the like, or any combination thereof).

In various examples, at least a portion or all of the functionalizing is carried out in situ. In various examples, at least a portion or all of the functionalizing is carried out in a device (such as for example, a battery or the like). In various examples, at least a portion or all of the functionalizing is carried out in a device (such as for example, a battery or the like) prior to the first bulk metal electrodeposition on the anode(s) and/or anode material(s) during routine operation of the battery.

A functionalizing may result in formation of a plurality of first functional groups. In various examples, an electrically conducting 3-D matrix (e.g., an electrically conducting 3-D carbon matrix or the like) comprising a plurality of first functional groups (which may be chemical bonding groups, oxygen-containing groups, or the like, or any combination thereof) is subjected to conditions such that at least a portion or all of the plurality of first functional groups is reacted to form a plurality of second functional groups (which may be chemical bonding groups, or the like, or any combination thereof). In various examples, the second functional groups are structurally distinct from the first functional groups.)

A method may comprise pre-treating an electrically conducting 3-D matrix (e.g., an electrically conducting 3-D carbon matrix or the like) to form one or more chemical bonding group(s) (or precursor(s) thereof) (e.g., two or more different chemical bonding groups (or precursor(s) thereof)). In various examples, a method comprises contacting an electrically conducting 3-D matrix (e.g., an electrically conducting 3-D carbon matrix or the like) with a composition that forms the chemical bonding groups. At least a portion of or all of the chemical bonding groups may be formed as a result of pre-treatment (e.g., oxidation in aqua regia or the like), which may be ex situ pre-treatment or in situ formation, of the electrically conducting 3-D matrix (e.g., the electrically conducting 3-D carbon matrix or the like), which may be before electrodeposition (e.g., first bulk electrodeposition in a device). At least a portion of or all of the chemical bonding groups may be formed as a result of contacting the electrically conducting 3-D matrix (e.g., the electrically conducting 3-D carbon matrix or the like) with an electrolyte. In various examples, at least a portion of or all of the chemical bonding groups are formed by two or more or all these approaches.

A composition may comprise (or be) a liquid phase composition, a gas phase composition, or the like. A combination of liquid phase composition(s) and gas phase composition(s) may be used. As an illustrative example, an electrically conducting 3-D matrix (e.g., an electrically conducting 3-D carbon matrix or the like) is contacted with a composition comprising one or more ionic liquid(s) and one or more aluminum halide(s) (e.g., AlCl₃, AlBr₃, AlI₃, or the like, or any combination thereof). Without intending to be bound by any particular theory, it is considered that the contacting results in, for example, formation of a plurality of —C—O—Al—X (e.g., X=Cl, Br, I, or any combination thereof), —C—O—Al—OH groups, —C—O—Al, or the like, or any combination thereof. As another illustrative example, an electrically conducting 3-D matrix (e.g., an electrically conducting 3-D carbon matrix or the like) with aqua regia, which may be at temperature of 60° C. or more. In various examples, a carbon cloth is contacted with hot (greater than 60° C.) aqua regia. Without intending to be bound by any particular theory, it is considered contacting an electrically conducting 3-D matrix (e.g., an electrically conducting 3-D carbon matrix or the like) with aqua regia provides an oxygen enriched electrically conducting 3-D matrix (e.g., an oxygen enriched electrically conducting 3-D carbon matrix or the like). In various examples, the composition comprises a liquid electrolyte (which may be an ionic liquid).

In various examples, the functionalizing comprises forming a graphene layer on at least a portion of one or more surface(s) (e.g., an exterior surface or the like) of the electrically conducting 3-D matrix (e.g., an electrically conducting 3-D carbon matrix or the like) (which may comprise one or more chemical bonding groups disposed on at least a portion or all of one or more or all of the surface(s) of the electrically conducting 3-D matrix (e.g., the electrically conducting 3-D carbon matrix or the like)). In various examples, the graphene layer is formed by chemical vapor growth, slurry dispersion, or the like. In the case of slurry deposition, a carbon cloth is contacted with a graphene suspension (e.g., in water or the like), and then the carbon cloth dried (e.g., under vacuum or at elevated temperature (e.g., 60° C.).

A method may further comprise electrochemically depositing a layer of an electrochemically active metal on at least a portion of one or more or all surface(s) of the electrically conducting 3-D matrix (e.g., the electrically conducting 3-D carbon matrix or the like). Without intending to be bound by any particular theory, it is considered that chemical bonding groups form one or more chemical bond(s) with at least a portion of the metal (which may be metal atoms and/or metal atom clusters) (e.g., electrochemically active metal, which may be electrochemically active metal atom(s) and/or electrochemically active metal atom cluster(s)) that is deposited (e.g., initially deposited) on the anode or the anode material during an electrochemical process (e.g., electrodeposition).

At least a portion of or all of the chemical bonding groups may be formed before electrodeposition (which may be a first bulk deposition in a device). At least a portion of the electrochemically active metal (which may be electrochemically active metal atoms and/or electrochemically active metal atom clusters) may be deposited (e.g., initially deposited) on the anode or the anode material during an electrochemical process (e.g., electrodeposition, which may be the first bulk electrodeposition in a device). In various examples, a method further comprises electrochemically depositing a layer of an electrochemically active metal (e.g., aluminum, zinc, lithium, sodium, calcium, magnesium, and the like), which may be referred to as an electrodeposited layer, disposed on at least a portion or all of one or more of the surface(s) of the functionalized electrically conducting 3-D matrix (e.g., the functionalized electrically conducting 3-D carbon matrix or the like). The layer of the electrochemically active metal may be deposited in a device (which may be referred to as in situ deposition). The layer of the electrochemically active metal may be deposited on an electrode or electrode material (e.g., electrically conducting 3-D matrix (e.g., electrically conducting 3-D carbon matrix or the like)) that is not in a device (which may be referred to as ex situ deposition). Without intending to be bound by any particular theory, it is considered that the deposition proceeds (e.g., at least initially proceeds) laterally (the layer growth is lateral growth) until 50% or greater, 60% or greater, 70% or greater, 80% or greater, 90% or greater, 95% or greater, or 100% of one or more surface(s) of the electrically conducting 3-D matrix (e.g., the electrically conducting 3-D carbon matrix or the like) is covered with a continuous layer of the electrochemically active metal.

In an aspect, the present disclosure provides devices. The devices comprise one or more anode(s) or anode material(s), or any combination of thereof, of the present disclosure and/or one or more anode(s), anode material(s), or a combination of thereof, formed by a method of the present disclosure. Non-limiting examples of devices are disclosed herein.

A device may be an electrochemical device. Non-limiting examples of electrochemical devices include batteries, supercapacitors, fuel cells, electrolyzers, electrolytic cells, and the like.

An anode or anode material may be formed in situ. In various examples a device (such as, for example, a battery or the like) is configured such that the anode(s) and/or anode material(s) are formed (e.g., by a method of the present disclosure) prior to the first bulk metal electrodeposition on the anode(s) and/or anode material(s) during routine operation of the battery.

An anode or anode material may have a metal (e.g., an electrochemically active metal) pre-plated (or electrodeposited) (e.g., prior to device fabrication, prior to first bulk electrochemically active metal deposition, or the like) onto the electrically conducting 3-D matrix (e.g., the electrically conducting 3-D carbon matrix or the like). An anode or anode material may not have a metal (e.g., an electrochemically active material) thereon (e.g., an electrochemically active metal pre-plated onto the electrically conducting 3-D carbon material), which may be referred to as an anode-free setup.

A device can be various batteries. Non-limiting examples of batteries include secondary/rechargeable batteries, primary batteries, and the like. A battery may be an ion conducting battery. Non-limiting examples of ion-conducting batteries include lithium-ion conducting batteries, sodium-ion conducting batteries, calcium-ion conducting batteries, magnesium-ion conducting batteries, aluminum-ion conducting batteries, zinc-ion conducting batteries, and the like. A battery may be a metal battery, such as, for example, a lithium-metal battery, a sodium metal battery, calcium metal battery, magnesium metal battery, aluminum metal battery, zinc metal battery, or the like. A device may be a solid-state battery or a liquid electrolyte battery.

A device, which may be a battery, may also comprise one or more cathode material(s). Non-limiting examples of cathode materials include conversion-type cathode materials, intercalation-type cathode materials, and the like. Examples of suitable cathode materials are known in the art.

In various examples, the cathode material(s) is/are one or more lithium-containing cathode material(s), one or more sodium-containing cathode material(s), one or more calcium-containing cathode material(s), one or more magnesium-containing cathode material(s), one or more aluminum-containing cathode material(s), one or more zinc-containing cathode material(s), or the like. Examples of suitable metal-containing cathode materials are known in the art. Non-limiting examples of lithium-containing cathode materials include lithium nickel manganese cobalt oxides, LiCoO₂, LiNi_{1/3}Co_{1/3}Mn_{1/3}O₂, LiNi_{0.5}Co_{0.2}Mn_{0.3}O₂, lithium manganese oxides (LMOs), lithium iron phosphates (LFPs), LiMnPO₄, LiCoPO₄, and Li₂MMn₃O₈, where M is chosen from Fe, Co, and the like, and any combination thereof, and the like, and any combination thereof. Non-limiting examples of sodium-containing cathode materials include Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄, Na_{2/3}Fe_{1/2}Mn_{1/2}O₂ @graphene composites, and the like, and any combination thereof. Non-limiting examples of magnesium-containing cathode materials include magnesium-containing materials (such as, for example, MgMSiO₄ (M=Fe, Mn, Co) materials and MgFePO₄F materials, and the like), FeS₂ materials, MoS₂ materials, TiS₂ materials, and the like. Any of these cathodes/cathode materials may comprise a conducting carbon aid.

A device, which may be a battery, may comprise a conversion-type cathode.

Non-limiting examples of conversion-type cathode materials include iodine, sulfur, sulfur composite materials, polysulfides, metal (e.g., transition metal or the like) sulfides, such as, for example, MoS2, FeS2, TiS2, oxides, selenides, fluorides, nitrides, phosphides, and the like, and any combination thereof.

A device, which may be a battery, may further comprise a solid electrolyte or liquid electrolyte. A liquid electrolyte may be an aqueous or non-aqueous liquid electrolyte. Examples of suitable electrolytes are known in the art.

A device may further comprise a current collector disposed on at least a portion of the cathode and/or the anode. In various examples, the current collector is a conducting metal or metal alloy.

A solid-state electrolyte, cathode, anode, and, optionally, the current collector may form a cell of a battery. The battery may comprise a plurality of the cells and each adjacent pair of the cells is separated by a bipolar plate. The number of cells in the battery is determined by the performance requirements (e.g., voltage output and the like) of the battery and is limited only by fabrication constraints. For example, the battery comprises 1 to 500 cells, including all integer number of cells and ranges therebetween.

The following Statements describe various examples of anode materials, anodes, methods, and devices of the present disclosure and are not intended to be in any way limiting:
Statement 1. An anode or an anode material, which may be a reversible anode or reversible anode material, the anode or the anode material comprising, consisting essentially of, or consisting of: an electrically conducting 3-dimensional (3-D) carbon matrix, which may be a non-planar electrically conducting 3-D carbon matrix, which may comprise a plurality of porous regions (e.g., voids), wherein at least a portion of, substantially all, or all of one or more or all of exterior surface(s) of the electrically conducting 3-D carbon matrix having a plurality of chemical bonding groups (CBGs) disposed thereon (e.g., chemically bonded to a surface of the electrically conducting 3-D carbon matrix).
Statement 2. An anode or an anode material according to Statement 1, wherein the chemical bonding groups are disposed on at least 25%, at least 50%, at least 75% of the exterior surfaces of the electrically conducting 3-D carbon matrix.
Statement 3. An anode or an anode material according to Statement 1 or 2, wherein the porous regions/voids are at least partially, substantially (e.g., a majority of the porous regions/voids are continuous), or completely continuous (e.g., in fluid contact).
Statement 4. An anode or an anode material according to any of the preceding Statements, wherein the porous regions/voids have one or more or all dimensions of 100 nm to 200 microns, including all integer nm values and ranges therebetween.
Statement 5. An anode or an anode material according to any of the preceding Statements, wherein the porous regions/voids are 30% or more, 50% or more, 75% or more, 90% or more, or 95% or more of the total volume of the electrically conducting 3-D matrix.
Statement 6. An anode or an anode material according to any of the preceding Statements, wherein the electrically conducting 3-D carbon matrix has a conductivity of 1 to 108 S/m, including all integer S/m values and ranges therebetween.
Statement 7. An anode or an anode material according to any of the preceding Statements, wherein the electrically conducting 3-D carbon matrix is chosen from carbon frameworks (e.g., carbon fibers, such as, for example, a plurality of carbon fibers or the like), carbon fabrics, carbon cloths, graphene aerogels, carbon nanotubes and derivatives or analogs thereof (e.g., oxygen-enriched carbon nanotubes and the like), vapor grown carbon fibers, activated carbon fibers, and derivatives or analogs thereof (e.g., oxygen-enriched derivatives or analogs thereof and the like), and the like, and combinations thereof).
Statement 8. An electrode or electrode material according to any of the preceding Statements, wherein the electrically conducting 3-D carbon matrix is disposed on a metal (which may be planar or non-planar).
Statement 9. An anode or an anode material according to any of the preceding Statements, the anode or the anode material further comprises a layer of an electrochemically active metal (e.g., aluminum, zinc, lithium, sodium, calcium, magnesium, and the like), which may be referred to as an electrodeposited layer, disposed on at least a portion or all of one or more surface(s) of the electrically conducting 3-D carbon matrix.
Statement 10. An anode or anode material according to Statement 9, wherein the layer of electrochemically active metal is chemically bonded to the electrically conducting 3-D carbon matrix via a plurality of chemical bonds.
Statement 11. A method of making an electrode or an electrode material of the present disclosure (e.g., an electrode or an electrode material according to any of Statements 1-10) comprising, consisting essentially of, or consisting of: functionalizing an electrically conducting 3-D carbon matrix, wherein a functionalized electrically conducting 3-D carbon matrix comprising a plurality chemical bonding groups (CBGs) disposed thereon (e.g., chemically bonded to a surface of the electrically conducting 3-D carbon matrix) is formed, or providing an electrically conducting 3-D carbon matrix comprising a plurality chemical bonding groups (CBGs) disposed thereon (e.g., chemically bonded to a surface of the electrically conducting 3-D carbon matrix).
Statement 12. A method according to Statement 11, wherein the functionalizing comprises contacting the electrically conducting 3-D carbon matrix with a composition that forms the chemical bonding groups.
Statement 13. A method according to Statement 11, wherein the functionalizing comprises forming a graphene layer on at least a portion of an exterior surface of the electrically conducting 3-D carbon matrix.
Statement 14. A method according to any of Statements 11-13, a method further comprising electrochemically depositing a layer of an electrochemically active metal (e.g., aluminum, zinc, lithium, sodium, calcium, magnesium, and the like), which may be referred to as an electrodeposited layer, disposed on at least a portion or all of one or more surface(s) of the electrically conducting 3-D carbon matrix, which may be a functionalized electrically conducting 3-D carbon matrix.
Statement 15. A device comprising, consisting essentially of, or consisting of: one or more anode(s) and/or one or more anode material(s) of the present disclosure (e.g., one or more anode(s) and/or one or more anode material(s) of any of Statements 1-10 and/or one or more anode(s) and/or one or more anode material(s) made by one or more method(s) of Statements 11-14.
Statement 16. A device according to Statement 15, wherein the device is an electrochemical device.
Statement 17. A device according to Statement 15 or 16, wherein the electrochemical device is a battery (e.g., a secondary/rechargeable battery, a primary battery, or the like), a supercapacitor, a fuel cell, an electrolyzer, an electrolytic cell, or the like.
Statement 18. A device according to any of Statements 15-17, wherein the battery is an ion-conducting battery.
Statement 19. A device according to Statement 17 or 18, wherein the battery or ion-conducting battery is an aluminum-ion conducting battery, a zinc-ion conducting battery, a lithium-ion conducting battery, a sodium-ion conducting battery, a calcium-ion conducting battery, a magnesium-ion conducting battery, or the like.
Statement 20. A device according to any of Statements 17-19, wherein the battery further comprises a cathode, and/or one or more electrolyte(s) (e.g., liquid electrolyte(s), such as, for example, carbonate-based, ether-based electrolytes, ionic liquid-based electrolytes, and aqueous electrolytes, and the like, solid-phase electrolyte(s), and the like) and/or one or more current collector(s) and/or one or more additional structural component(s).
Statement 21. A device according to Statement 20, wherein the one or more additional structural component(s) is/are chosen from bipolar plates, external packaging, electrical contacts/leads to connect wires, and the like, and combinations thereof.
Statement 22. A device according to any of Statements 17-21, wherein the battery comprises a plurality of cells, each cell comprising one or more anode(s) and/or one or more anode material(s), and optionally, one or more cathode(s), one or more electrolyte(s), one or more current collector(s), or a combination thereof.
Statement 23. A device according to Statement 22, wherein the battery comprises 1 to 500 cells.
Statement 24. A device according to any of Statements 15-23, wherein the battery exhibits one or more or all of the following:
   an areal capacity of at least 0.5, at least 0.1, 0.5, at least 1, or at least 5 mAh/cm² or 0.5 to 10 mAh/cm², including all 0.1 mAh/cm² values and ranges therebetween;
   an areal capacity of at least 0.5, at least 0.1, 0.5, at least 1, or at least 5 mAh/cm² or 0.5 to 10 mAh/cm², including all 0.1 mAh/cm² values and ranges therebetween, and a cycle life of at least 100 cycles, at least 500 cycles, at least 1000 cycles, at least 2500 cycles, at least 5000 cycles, at least 7500 cycles, or at least 10,000 cycles;
   an areal capacity of at least 0.4 or at least 1 mAh/cm² at a charging rate of 40 mA/cm² for at least 100 cycles, at least 500 cycles, at least 1000 cycles, at least 2500 cycles, at least 5000 cycles, at least 7500 cycles, or at least 10,000 cycles;
   a coulombic efficiency of 98% or greater, 99% or greater, or 99.5% or greater.

The steps of the methods described in the various embodiments and examples disclosed herein are sufficient to produce an electrode or electrode material or catalyst or catalyst material of the present disclosure. Thus, in various examples, a method consists essentially of any combination of the steps of the methods disclosed herein. In various other examples, a method consists of such steps.

The following examples are presented to illustrate the present disclosure. The examples are not intended to be limiting in any manner.

### EXAMPLE 1

The following is an example of anodes and anode materials, methods of making anodes and anode materials, and devices of the present disclosure.

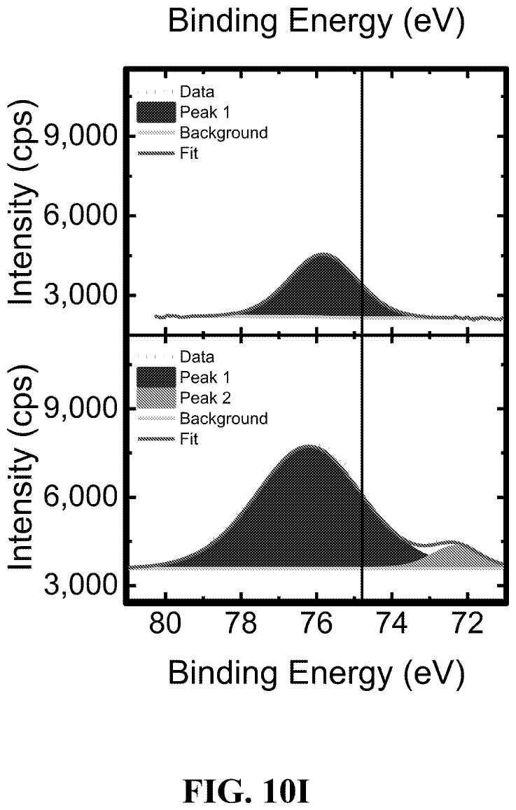

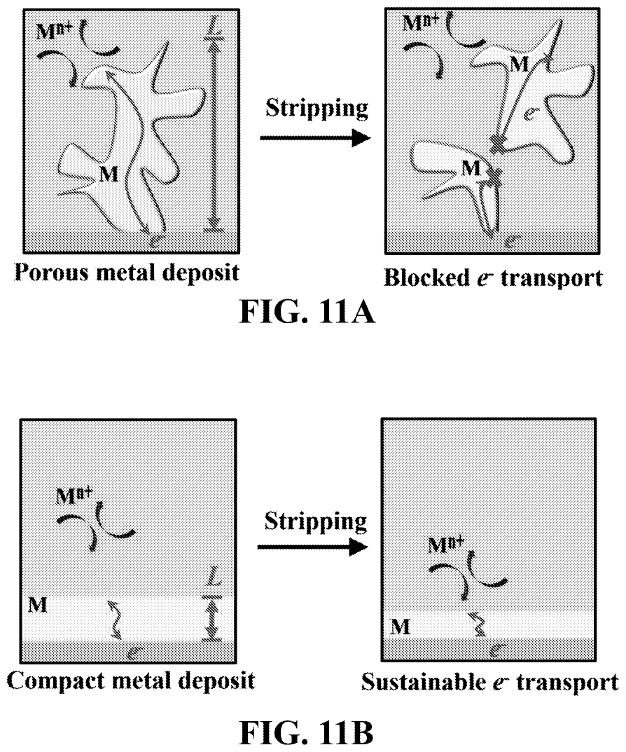

While Li-based batteries have established a dominant role in the current energy storage landscape, post-Li chemistries (e.g., Al or Zn) are emerging as promising candidates for next-generation batteries. Electrochemical cells using Al or Zn metal as the negative electrode are of interest for their potential low cost, intrinsic safety and sustainability. Presently such cells are considered impractical because the reversibility of the metal anode is poor and the amount of charge stored is miniscule. In this example, electrodes designed to promote strong oxygen-mediated chemical bonding between Al deposits and the substrate are reported that enable fine control of deposition morphology and provide exceptional reversibility (99.6%˜99.8%) were fabricated. The reversibility is sustained over unusually long cycling times (greater than 3600 hours) and at areal capacities up to two orders of magnitude higher than previously reported values. These traits are shown to result from elimination of fragile electron transport pathways and non-planar deposition of Al via specific metal-substrate chemical bonding. The hypothesis that guides the present disclosure is that the fragility of the electron transport pathways is the fundamental barrier to fully reversible metal electrodeposition processes (FIGS. 11A-11B).

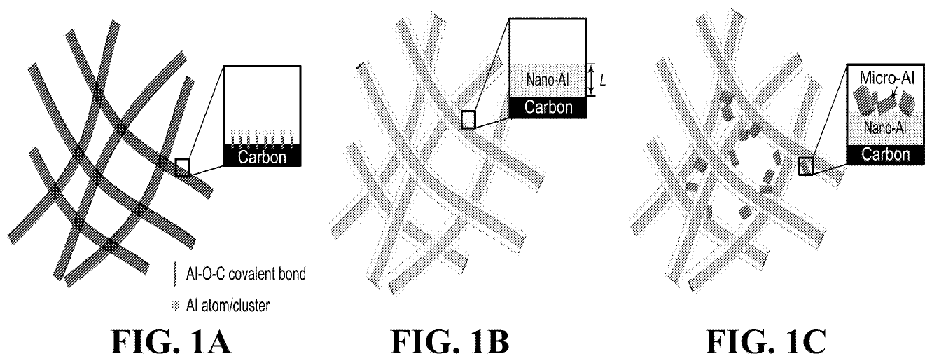

In this example, electrodeposition of metals in patterned substrates designed to strongly coordinate with the metal deposit via surface chemical bonding (FIGS. 1A-1C) was investigated. It was considered that strong metal-substrate bonding increases the driving force for nucleation, yielding a uniform distribution of small metal nuclei. The uniformly distributed nuclei enable compact, uniform deposition, producing deposits with controlled thickness, L. during the growth phase. The straightforward effect of such control is that the electron transport time scale, τ˜L²/D, which sets the effective exchange current density at the electrode, can be readily manipulated. Here 1/D is the electron mobility. It was therefore considered that the presence of strong metal-substrate bonding provides a mechanism for narrowing the distribution to produce compact deposits, allowing us to control t and thereby maintain high reversibility. This was experimentally tested using Al metal as a model system.

On substrates where interfacial chemical bonding is not detected, Al persistently forms coarse, heterogeneous electrodeposits, regardless of the geometry of the substrates. By contrast, the Al deposition morphology on carbon fibers treated by ionic liquid+AlCl₃ is highly uniform across multiple length scales. The uniform Al deposition is enabled by Al—O—C bonds formed on the substrate surface, as evidenced by x-ray photoelectron spectroscopy. Such precise regulation on morphology is shown to markedly improve the electrochemical performance of the Al electrodes.

Electrodeposition of Al Metal in Conventional Battery Anodes. The rationale for choosing Al is straightforward—intrinsically safe, low cost and energy dense Al batteries are considered prospective alternatives to Li-ion batteries (see Table 1), in applications such as backup storage for electric power generation from intermittent, renewable sources, where cost and scalability are critical. Table 1 shows a summary of the abundance, volumetric specific capacity and gravimetric capacity of representative anode metals. Energy density is calculated according to electrochemical potential versus standard hydrogen electrode.

TABLE 1

| | | | | Volumetric | Gravimetric |
|---|---|---|---|---|---|
| | | Volumetric | Gravimetric | energy | energy |
| Anode | Abundance | capacity | capacity | density | density |
| Material | (ppm) | (mAh/mL) | (mAh/g) | (Wh/L) | (Wh/kg) |
| Al | 83186 | 8046 | 2980 | 13350 | 4768 |
| Na | 22909 | 1181 | 1166 | 3188 | 3148 |
| Zn | 79 | 5846 | 820 | 4442 | 623 |
| Li | 13 | 2093 | 3862 | 6362 | 11740 |
| Graphite | N/A | 790 | 300 | 2212 | 840 |

Al has the highest abundance, the highest volumetric specific capacity and the highest volumetric energy density. Particularly, the ionic liquid electrolyte system used in Al batteries has a wide electrochemical stability window. The operating voltage can be further improved by developing next-generation cathode materials compatible with the Al chemistry. As a result, Al metal anode emerges as a competitive alternative to commercial Li-ion anodes and even to Li metal anodes.

Additionally, the reversible plating/stripping of Al was demonstrated in 2011, which motivated a strong revival of research interest into Al metal anodes for rechargeable batteries. As a final point, innovations in the design of reversible cathode materials compatible with Al metal anodes have produced batteries of exceptional promise, albeit at impractically low areal specific capacities (0.01˜0.18 mAh/cm²), i.e., nearly two orders of magnitude lower than that of state-of-the-art Li-ion batteries (1˜3 mAh/cm²) (see Table 2). Table 2 shows anode metal plating/stripping throughput per cycle for Al-ion electrochemical cells using metallic Al foil anodes. Shown are typical studies that disclose the area-specific parameters as representative references. * Modified Al metal anodes are used in these studies.

TABLE 2

| | Areal Capacity of | Life | |
|---|---|---|---|
| Year | Al Deposition (mAh/cm²) | Time (hr) | Configuration |
| 2015 | 0.10 | 240 | pouch |
| 2015 | 0.14-0.42 | 500 | coin |
| 2016 | 0.15 | 200 | pouch |
| 2016 | 0.08 | 120 | pouch |
| 2017 | 0.1-0.3 | 500 | coin |
| 2017 | 0.12 | 600 | pouch |
| 2017* | 1.25 | 600 | coin |
| 2018 | 0.008-0.08 | 200 | pouch |
| 2018 | 0.015-0.06 | 40 | coin |
| 2018* | 0.4 | 1000 | coin |
| 2019 | 0.0675 | 150 | pouch |
| 2019 | 0.03~0.08 | 600 | coin |
| 2020 | 0.18 | 30 | pouch |
| 2020* | 0.1~0.5 | 170 | coin |
| This work* | 8 | 3600 | coin |
| This work * | 0.4~0.5 | 100 | anode-free pouch |

The areal electrode specific capacity is an important-but oftentimes overlooked-battery parameter. Fundamentally, using an impractically low areal capacity means that the intrinsic anode failure modes discussed above might be obscured by an inter-electrode spacing that is too large. From an applications perspective, the disproportionately large contribution from inactive battery parts to the overall weight and volume leads to a lower overall cell energy density, and elevated cost per unit of energy stored. The slow progress in addressing this issue raises concern about the actual potential of Al-based batteries as next-generation energy storage systems. Building Al metal anodes that sustain prolonged cycling at practical areal capacities is therefore a critical step towards commercially-relevant Al batteries.

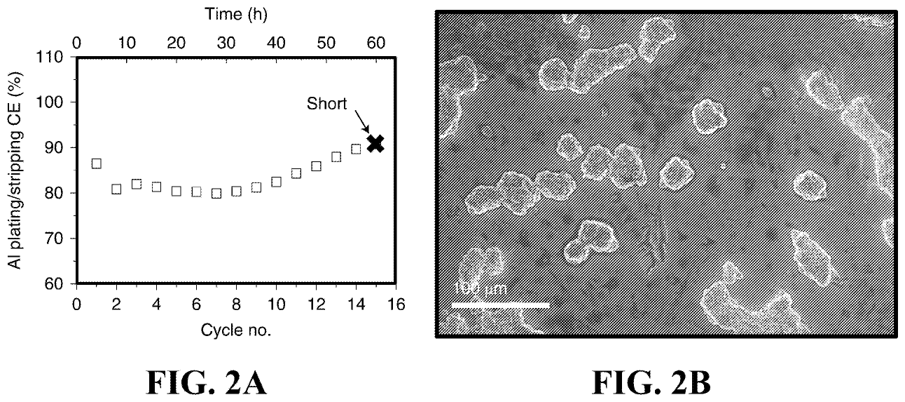

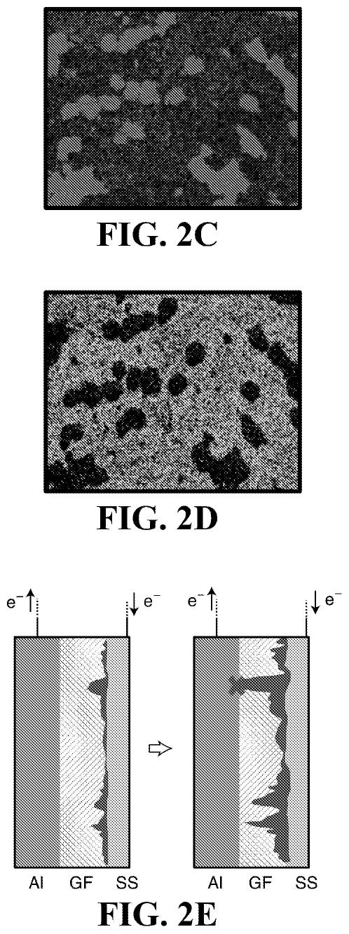

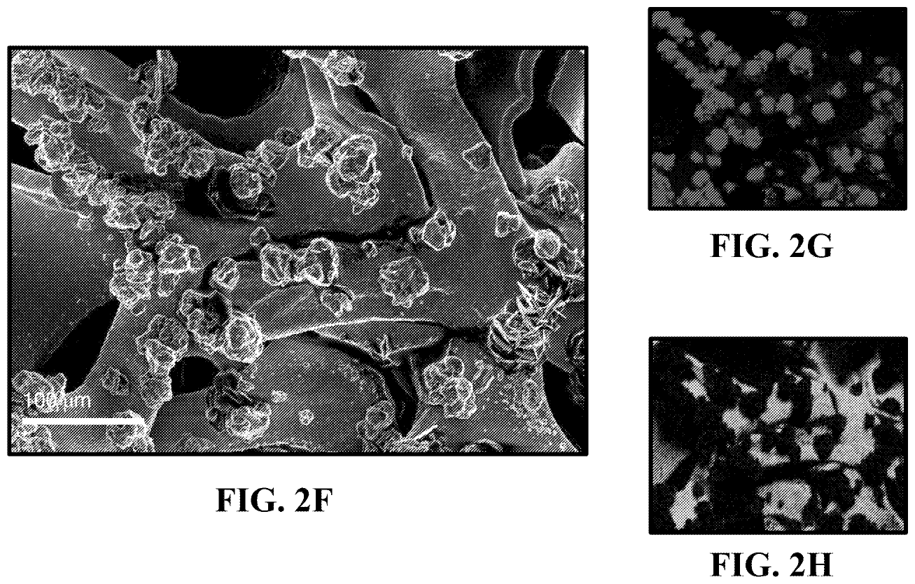

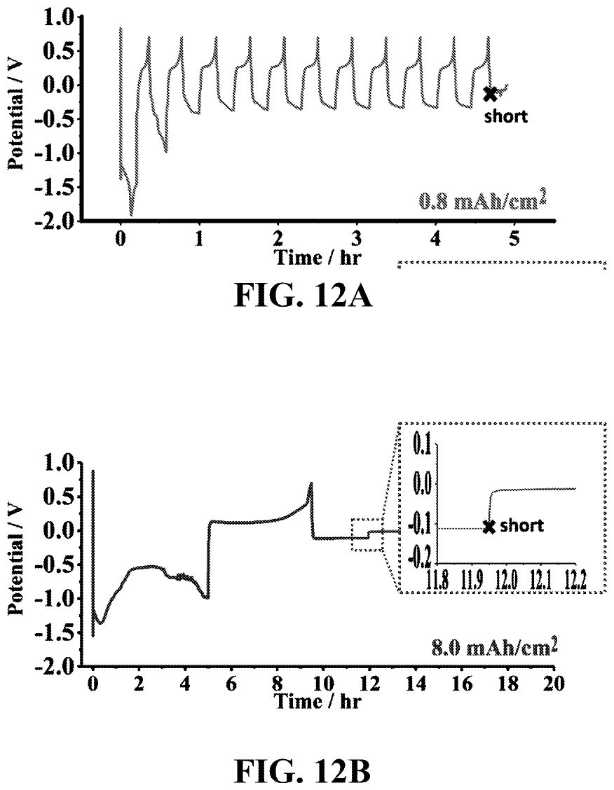

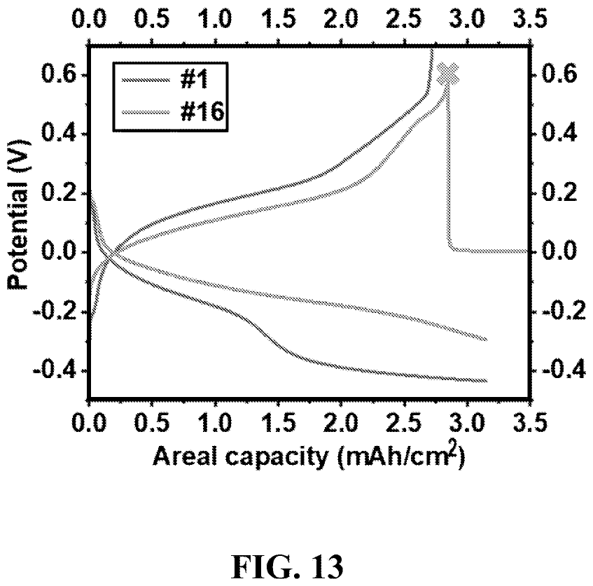

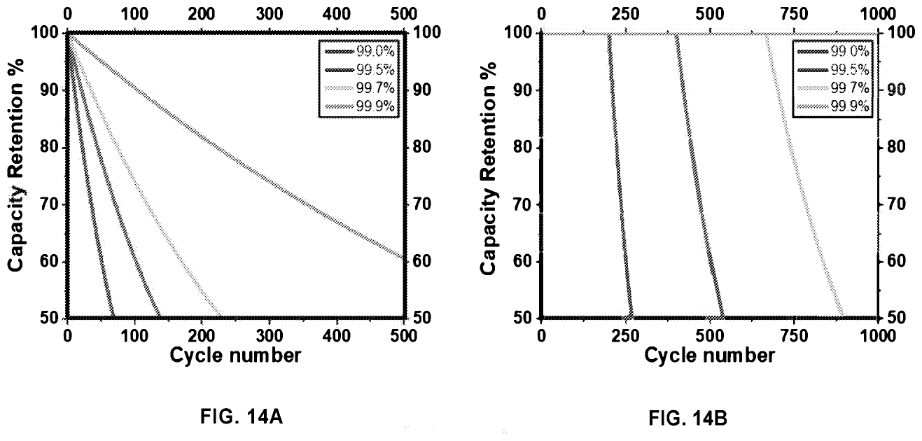

The performance of metallic Al anodes was assessed at elevated areal capacities (0.8˜8 mAh/cm²) by plating and stripping Al metal on a conventional, planar stainless steel substrate. Surprisingly, the electrochemical cells failed quickly (less than20 hours) by short-circuiting at these high capacities (FIGS. 12A-12B). To evaluate the plating/stripping reversibility of Al at practical areal capacities—without disruptions due to battery shorting—multiple layers of separator were intentionally placed in the inter-electrode space. The plating/stripping reversibility (i.e. Coulombic Efficiency, CE) was thereby measured to be approximately 85%, meaning that 15% of Al deposits are irreversibly lost in each cycle (FIG. 2A, voltage profile in FIG. 13). As depicted in FIGS. 14A-14B, a practical Al anode would require a CE of 99%, preferably above 99.5%. It is also noted that even with multiple separators, the 3.2 mAh/cm² cell failed after only ˜60 hr. Together, (a) the rapid battery shorting and (b) the low plating/stripping reversibility, at elevated areal capacities impose fundamental, pressing challenges for practical Al batteries.

To diagnose the underlying problems, scanning electron microscopy (SEM) was performed to characterize the electrodeposit morphology. SEM results in FIG. 2B show that the Al deposits exhibit a heterogeneous, non-planar morphology. Consistent with prior reports, the Al deposits are as large as 20˜50 μm, sparsely distributed on the substrate, and isolated from each other. This leads to large and broadly distributed L and τ values, which would in turn produce sluggish, incomplete metal stripping. As illustrated in FIG. 2C, this is precisely what was observed. It is concluded that the low plating/stripping efficiency and the battery shorting in Al anodes are consequences of the localized, aggressive growth of the Al electrodeposits normal to the substrate plane. The literature was followed and the non-planar Al electrodeposit growth was loosely referred to as dendritic but was shown to be unusually aggressive and to possess previously unreported characteristics that appear to arise from the strong affinity of Al for the separator.

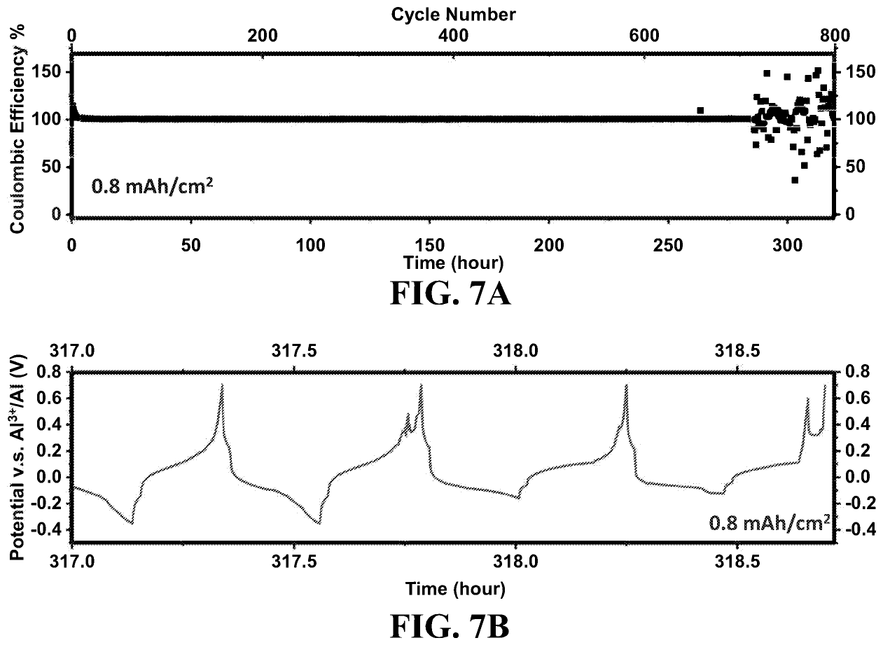

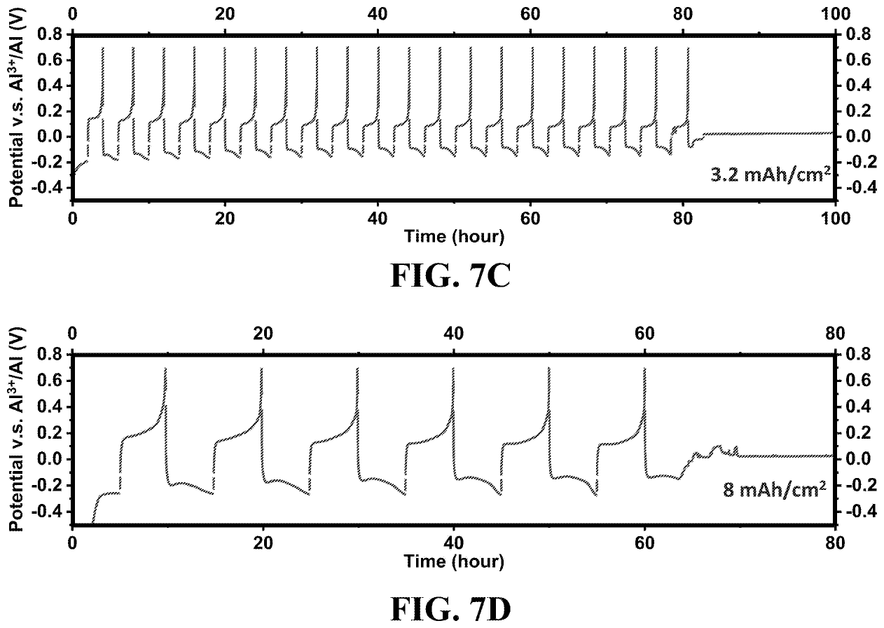

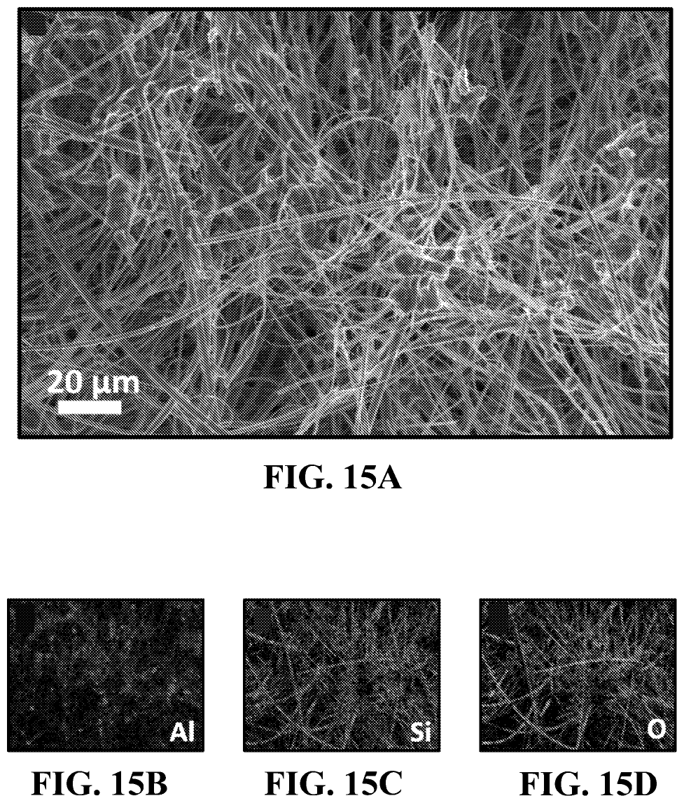

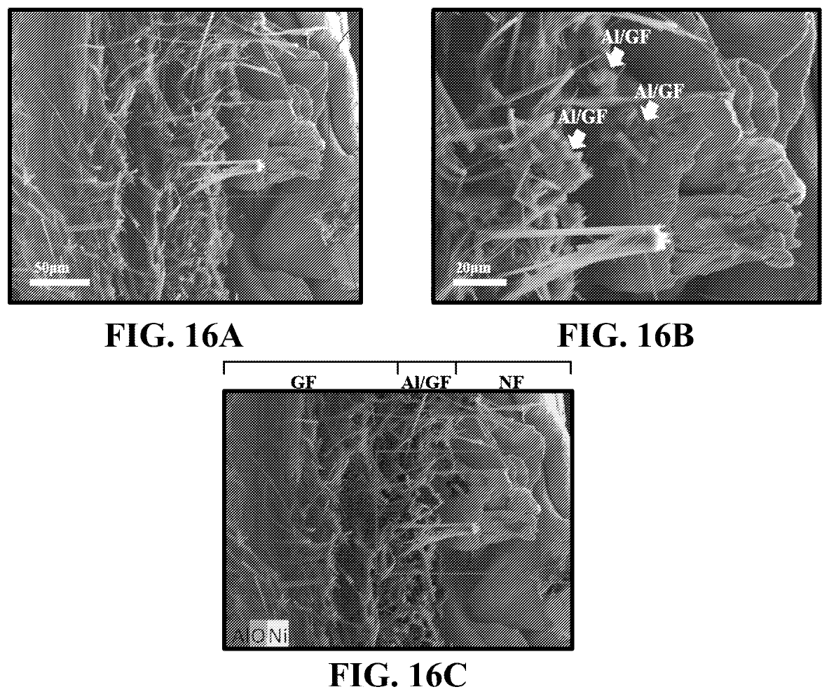

The speed with which these Al electrodes failed by short-circuiting—even at conventional electrode areal capacities—exceeded typical values for Li anodes, implying that the materials physics that control the non-planar electrodeposition of Al are quite different. It also explains the rather low areal capacity limits explored in previous studies. It is further noted that whereas deposition of Li in a three-dimensional porous material such as a nickel foam can substantially extend the time-to-failure due to short-circuiting, deposition of Al in a nickel foam substrate (FIG. 2D) has at most a negligible impact on the deposition morphology. Consequently, using nickel foam as anode substrate exhibited a rather limited improvement on the electrochemical performance (FIGS. 7A-7D). The first clues to understanding the aggressive non-planar deposition of Al is that glass fiber (SiO₂) membranes, rather than organic polymers are used as the separator. This choice stems from the fact that typical polyolefin separators are chemically unstable in the imidazolium chloride +AlCl₃ electrolyte melt. Early literature reports showed that there is a possibility for strong chemical affinity between metallic Al and SiO₂ via an interfacial reaction: 4Al+3SiO₂→2Al₂O₃+3Si, implying that in addition to the other factors that may drive nonplanar metal electrodeposition, a chemical driving force favors growth of Al electrodeposits into the separator. This growth mode was confirmed using SEM and EDS analysis on either a stainless steel or a nickel foam substrate (FIGS. 15A-15D, FIGS. 16A-16C), explaining the speed with which Al is able to short-circuit cells even when multiple layers of separator membranes are used or when the deposition is performed using a nickel foam substrate.

Uniform Al Deposition Enabled by O-mediated Metal-substrate Bonding. The discovery disclosed in this Example poses the question: could the propensity of Al to grow into the separator be countered by creating metal-substrate bonding that is strong enough to chemically usher Al into a patterned substrate? This question can be theoretically reasoned by an analysis of the nucleation process in electrodeposition, which plays a pivotal role in determining the size, uniformity and distribution of electrodeposits. Upon the application of voltage, the initial process is the desolvation of the coordinated species in the electrolyte as they approach the negatively charged electrode surface. In this desolvation process, the metal-containing species are converted into a cationic form by losing the coordinating ions/molecules. The subsequent step is the electrochemical adsorption of the species: Mnⁿ⁺+ne⁻+*→M*, where * refers to the adsorption site and M* to the adsorbed metal. This reaction can be dissociated into two steps: (a) electrochemical reduction of the metal: Mⁿ⁺+ne⁻→M_{(free)}, and (b) binding with the substrate: M_{(free)}+*→M*, which directly depends on the interaction between the metal and the substrate; the nucleation overpotential is determined by the free energy change ΔG of the latter. Classical nucleation theory would then imply that strong metal-substrate bonding results in smaller critical nucleate size, r_{c}=−2 γ/ΔG, where γ is the energy penalty for creating unit area of the metal surface and ΔG is the Gibbs free energy associated with formation of the condensed metal phase during the earliest stages of nucleation.

Implementation of this concept in a battery anode is not straightforward, because the nucleation occurs on an electronically conducting substrate, meaning it is never strictly homogeneous. As discussed earlier, the formed metal nuclei may also make strong bonds with either the separator, substrate, or both, which will affect their shape. Additionally, to achieve high electrode reversibility, the geometrical and chemical integrity of the substrate must remain intact over repeated cycles of metal plating/stripping. On this basis, a screening framework for promising substrate material was proposed as follows: the substrate should be electrically conductive, mechanically robust and capable of forming interfacial metal-substrate bonding. It is important that the chemical reaction between the substrate and the metal is limited within the interface, rather than penetrating the bulk. A bulk reaction, owing to the crystallographic and volume changes associated, inevitably gives rise to morphological instabilities of the substrate over cycling.

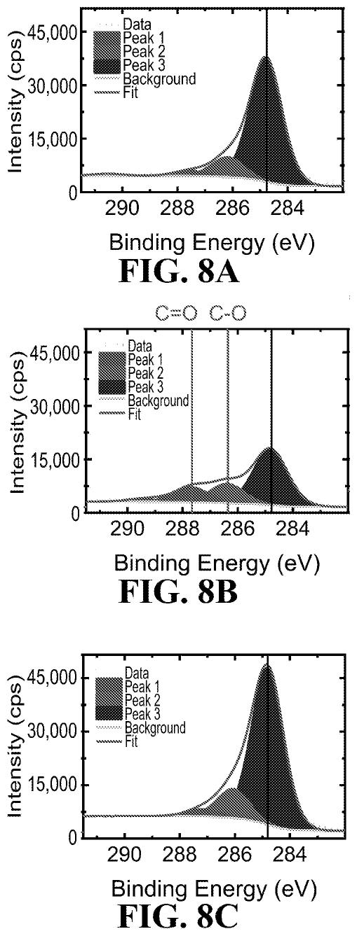

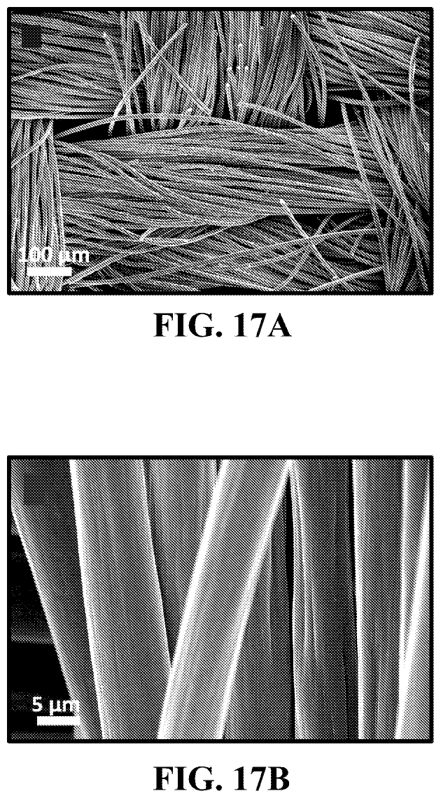

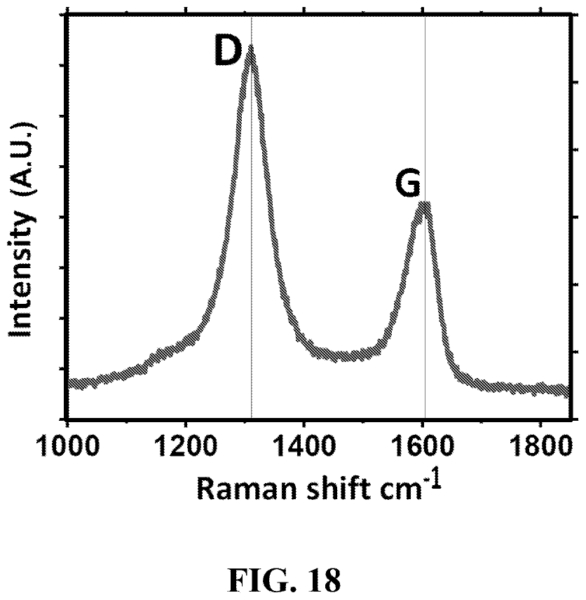

In screening for potential substrate materials, free-standing interwoven carbon fibers (SEM in FIGS. 17A-17B) were singled out because previous studies show that these materials form multiple types of interfacial covalent bonds, including Al—C, Al—O—C, etc. with Al metal during electroplating. The calculated binding energy of Al—O—C is as high as a few electron-volts, meaning that the driving force for Al to grow on the substrate surface is rather large. This characteristic was previously utilized to electroplate a uniform Al pre-coating layer on carbon, which improved the Al/C wettability in subsequent metallurgical manufacturing of Al/C composite materials. This carbon-based material is of specific interest here also because the bonding occurs via interfacial interaction at oxygen-enriched defective sites on the surface rather than bulk phase transition. Of note is that the Raman spectrum of the interwoven carbon fibers shows both the D band and G band (FIG. 18). It means that the carbon contains a considerable number of defects, which reportedly promotes the bonding with Al. XPS characterization (FIGS. 8A-8C) shows that exposure of carbon fibers to the imidazolium Cl+AlCl₃ electrolyte significantly increased the level of oxygen enrichment without altering the microstructure of the substrate. On these bases, in a nonplanar architecture made of interwoven carbon fibers, the possible chemical metal-substrate bonding between C and Al mediated by oxygen is then hypothetically able to promote uniform Al growth on individual carbon fibers (FIGS. 1A-1C), as opposed to the macroscopic outer surface of the architecture as shown in FIGS. 15A-15D and FIGS. 16A-16C.

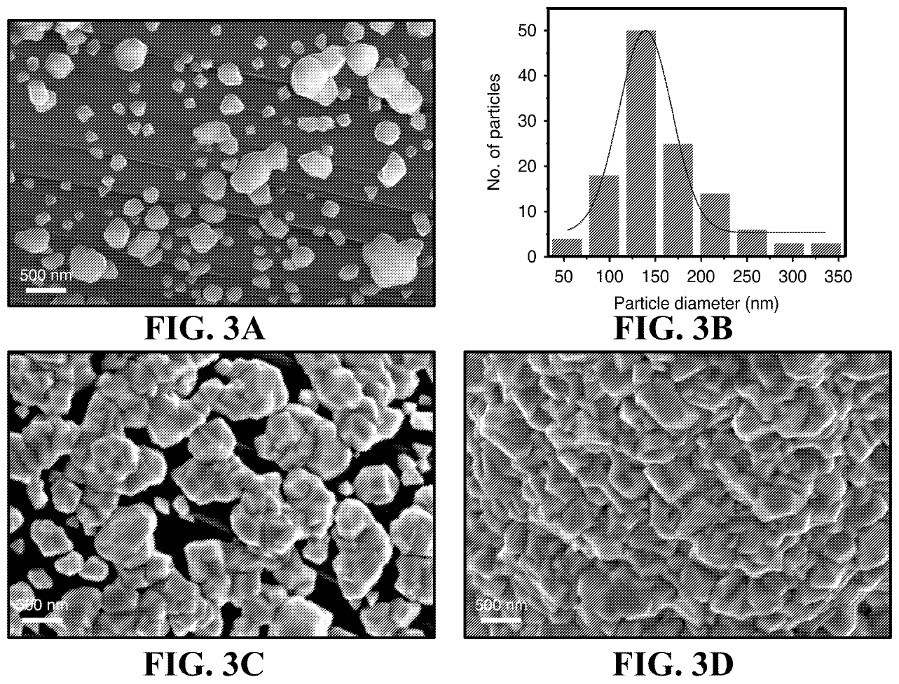

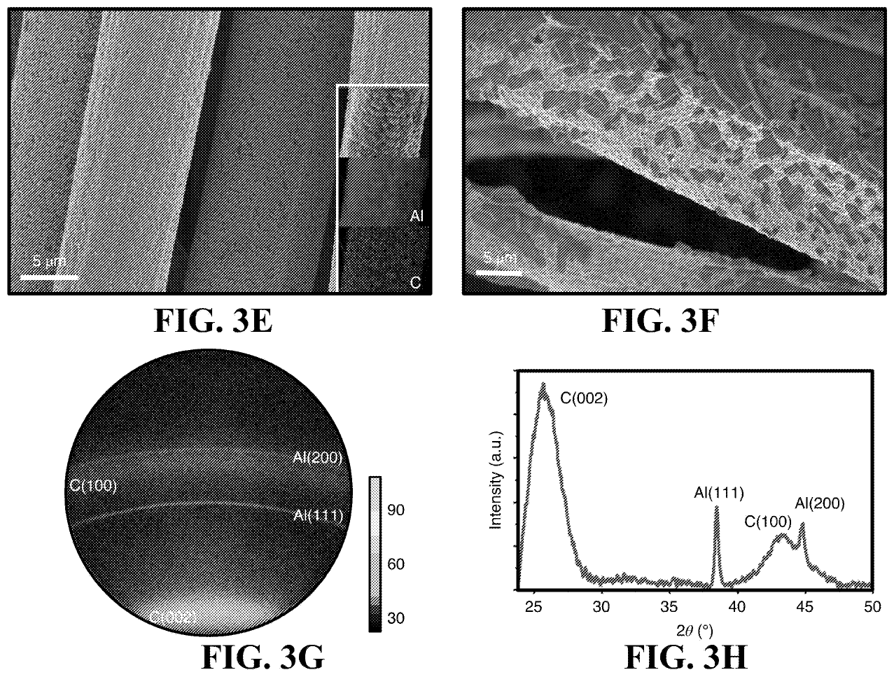

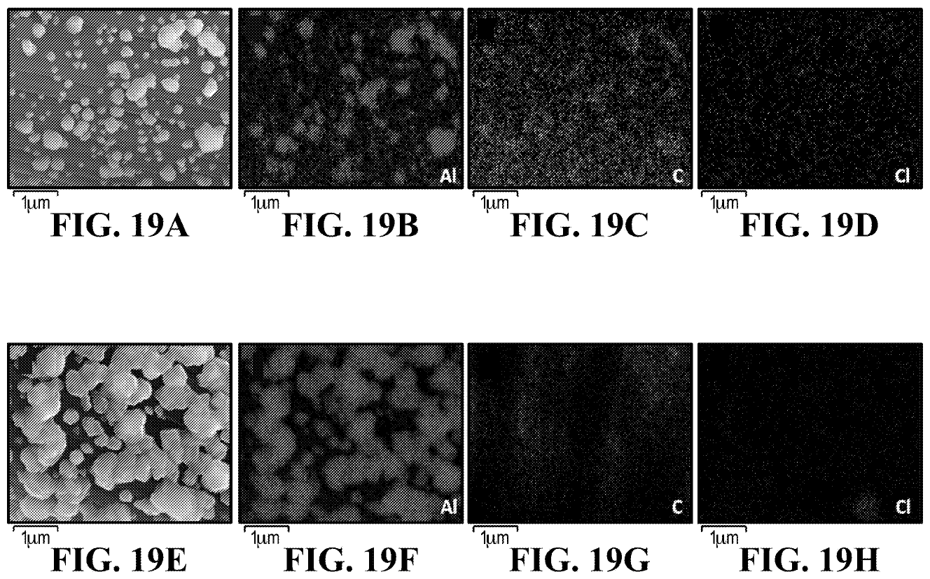

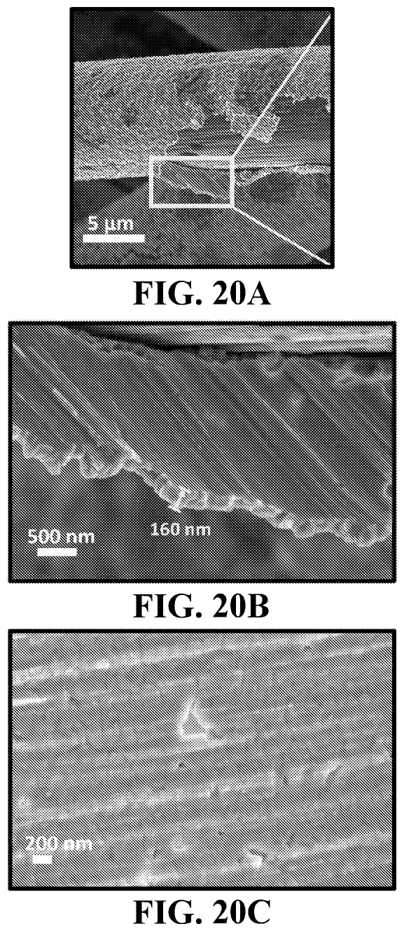

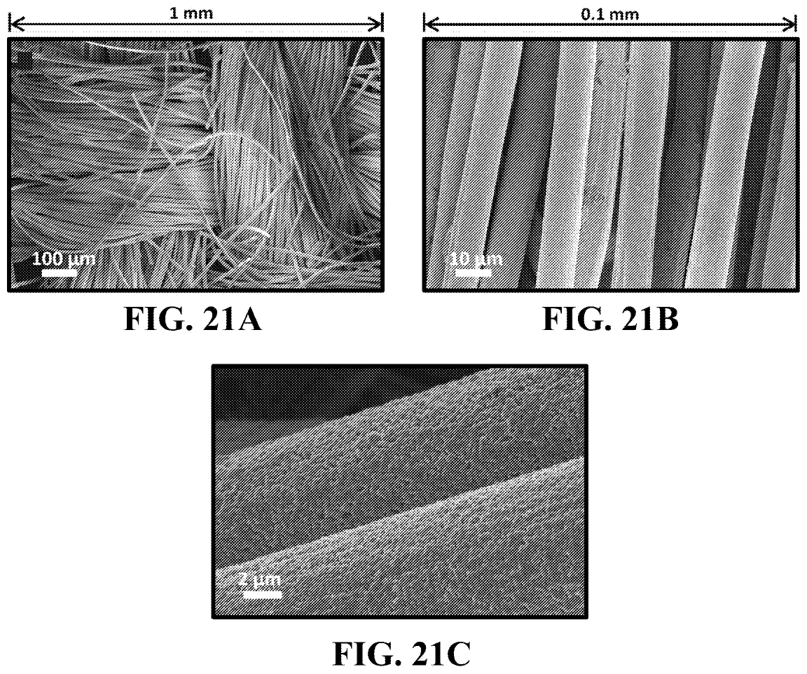

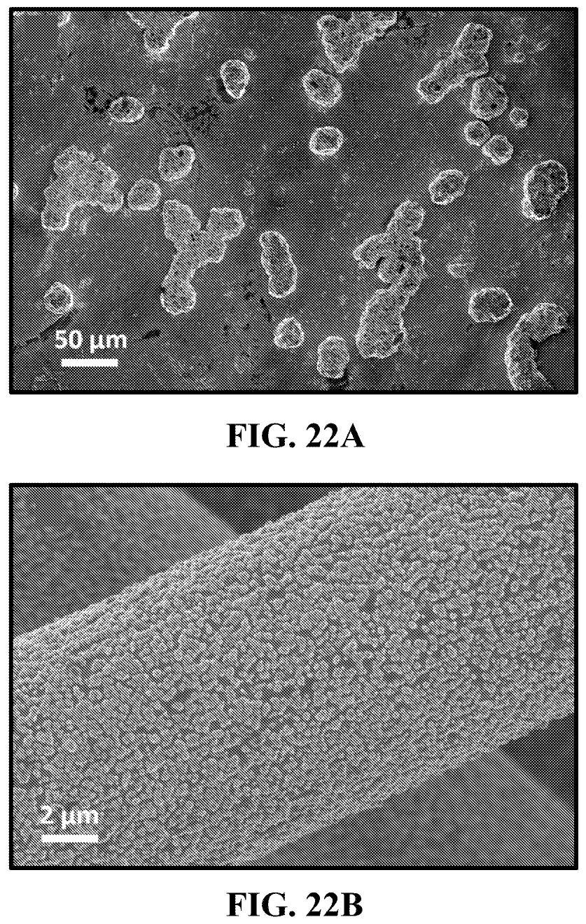

FIGS. 3A-3H report the main results of the studies of this Example. The Al metal electrodeposition morphology on interwoven carbon fibers was investigated using SEM. In stark contrast to the Al deposited on planar stainless steel and on nonplanar nickel foam, where deposit sizes are quite variable with average values of L on the order tens of microns, the Al electrodeposits in on carbon fiber surface with L are typically in the range of 100˜200 nanometers in the nucleation stage (FIGS. 3A-3B); meaning that for a fixed D, τ could be reduced by a factor of 10,000 or more. As the deposition capacity increases, the nanoscale Al crystals grow laterally (FIGS. 3C-3E, supplementary EDS in FIGS. 19A-19H), i.e. expand along the carbon surface, generating a conformal Al coating layer of a thickness on the order of 102 nm (e.g. 160 nm, see FIGS. 20A-20C) that appear to strictly follow the surface curvature (FIG. 3D). FIGS. 20A-20C also show the morphology of the Al deposit layer facing the carbon fiber-nanoscale Al grains are seen to merge into a compact layer. The Al deposition morphology is highly uniform across a macroscopic area as shown in FIGS. 21A-21C, without any observable aggressive/dendritic growth. Microstructural characterization of the morphology after thermal annealing shows that surface diffusion is not an as effective mechanism for smoothing the Al electrodeposits (FIGS. 22A-22B); rather, the initial uniform nucleation promoted by metal-substrate bonding is playing a dominant role. These results confirm that the strong metal-substrate bonding is able to (a) guide a metal electrodeposition precisely using the surface topography of a strongly interacting non-planar architecture; and (b) promote the uniform nanoscale nucleation and lateral growth of metal deposits to create compact film.

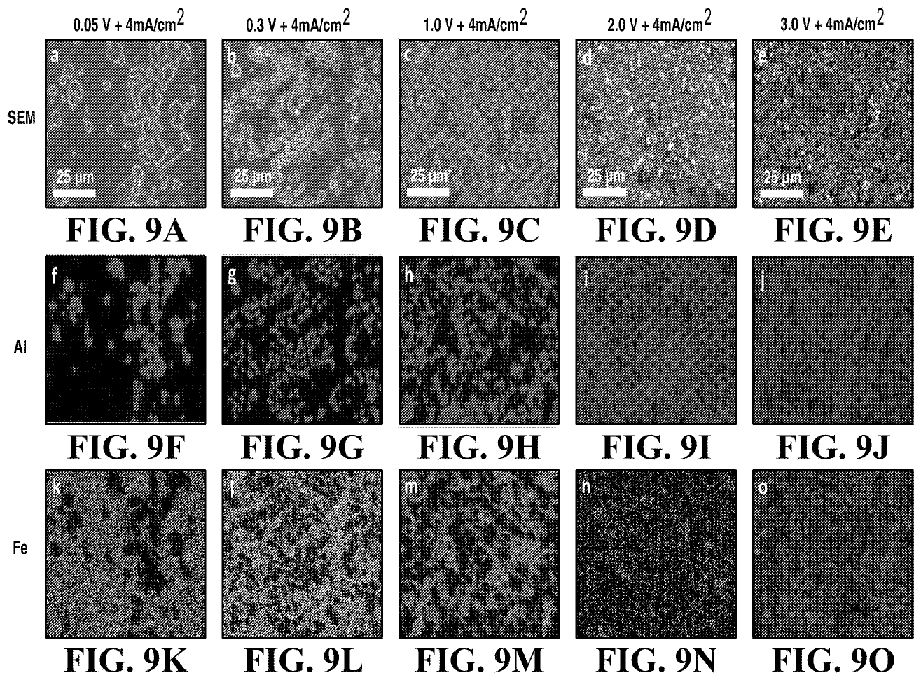

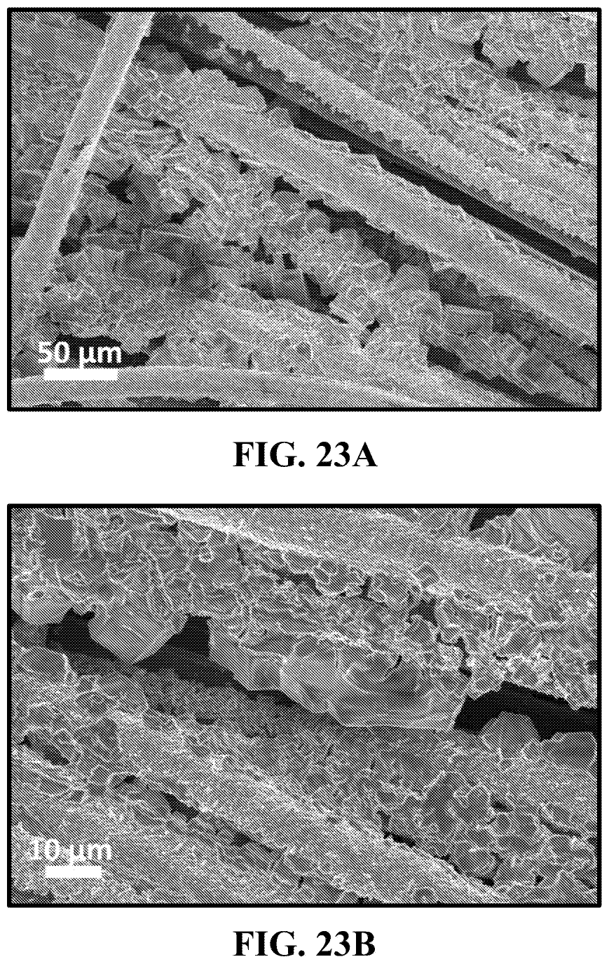

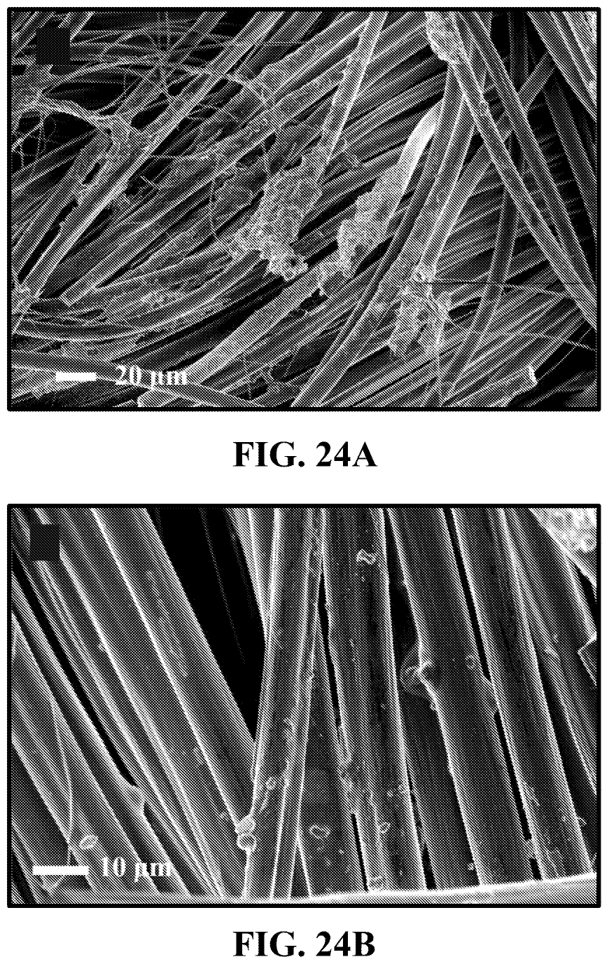

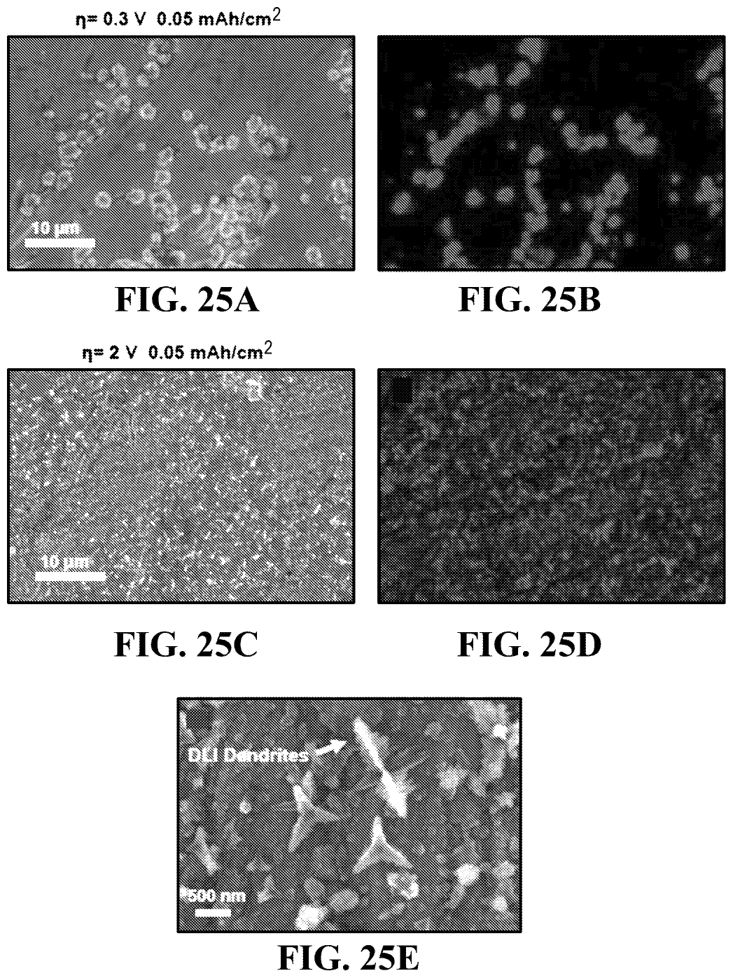

The deposition capacity was increased beyond 3 mAh/cm² and it was observed that the growth of Al enters a second stage (FIGS. 1A-1C): growth of microscale Al crystals on the compact nanoscale Al layer (FIG. 3F). X-ray diffraction in FIGS. 3G-3H verifies that only Al crystals are present on the carbon substrate fibers. The microscale Al deposits gradually fill the space among the carbon fibers (morphology at 8 mAh/cm² shown in FIGS. 23A-23B). The microscale Al deposits are intimately connected to the compact nanoscale Al layer and to each other. This observation confirms that the metal-substrate bonding has a decisive influence on the Al deposition morphology. After the substrate surface is fully occupied by the compact nanoscale Al layer, the newly deposited Al crystals resume the intrinsic growth mode at the micron scale. As a more direct control experiment, the carbon fibers were artificially pre-coated with an interphase that blocks the possible Al—O—C bonding, and evaluated Al electrodeposition morphology on this “deactivated” carbon fiber matrix (FIGS. 24A-24B). The SEM characterization shows that the Al deposition is no longer uniform over the surface of carbon fibers. This negative control experiment validates the presently disclosed hypothesis that oxygen-enriched surface chemistry is playing an indispensable role in realizing the control over deposition morphology. Moreover, a group of physical simulation experiments was devised to more quantitatively understand the role played by a large driving force at the nucleation stage and its impact on the ultimate deposition morphology (FIGS. 9A-9O/Note 1, FIGS. 25A-25E/Note 2).

Discussion of the Al deposition morphology shown in FIGS. 9A-9O. The key idea is that if the first hypothesis in the main text—chemical bonding of Al facilitates Al nucleation by providing an additional thermodynamic driving force, which lowers the nucleation barrier—is correct, one should be able to simulate the effect physically by application of a large overpotential during the nucleation stage. The second step allows us to evaluate the second hypothesis, namely that the initial potential-determined nucleation landscape will dominate the subsequent growth of the metal in galvanostatic deposition at a conventional current density. Additionally, by manipulating the overpotential during the nucleation step over a wide range, the approach facilitates a more quantitative assessment of the effect. FIGS. 9A-9O show that there is a clear dependence of the ultimate deposition morphology on the initial nucleation driving force. Specifically, the Al electrodeposits are clearly finer in size, more uniform in spatial distribution as the initial nucleation driving force increases from 0.05 to 3V. A clear transition occurs within the range of 1.0 V˜2.0 V; the Al electrodeposition morphology changes from isolated to merged domains, as can be best seen in the EDS mapping results. A physically-imposed overpotential greater than 2 V in the nucleation stage is able to drive the uniform nucleation and growth of Al. It is noted that n values of 0.05 V and 0.3V are within the range of conventional overpotentials observed in Al electrodeposition at normal current densities. And the resultant morphologies under these two conditions are consistent with the results obtained in galvanostatic Al deposition (e.g., see FIGS. 2A-2H). It is possible to roughly estimate the chemical bond strength required to achieve the analogous effect in the presently disclosed galvanostatic experiments. For example, an overpotential of 2.0 V would provide a driving force analogous to that produced by a binding energy of −2V×3e=−6 eV (owing to the trivalency of Al³⁺). This estimated value is on the same order of magnitude as the DFT simulated bonding strengths of Al—O—C reported in previous literature. It is shown that with a nucleation driven by a large overpotential of 2V, uniform Al growth is achieved at the subsequent stage of deposition under conventional constant current conditions. This set of results confirms that a large driving force imposed in the initial nucleation process serves as a determinant factor in achieving uniform Al deposition. However, this physical approach is fundamentally associated with chemical and hydrodynamic instabilities, making it unsuitable for battery applications (see Note 2). Further molecular-level simulation of this process could be obtained by Joint Density Function Theory methods that capture the detailed kinetical steps near a solid-liquid interface, e.g., desolvation, bonding, and interphase formation.

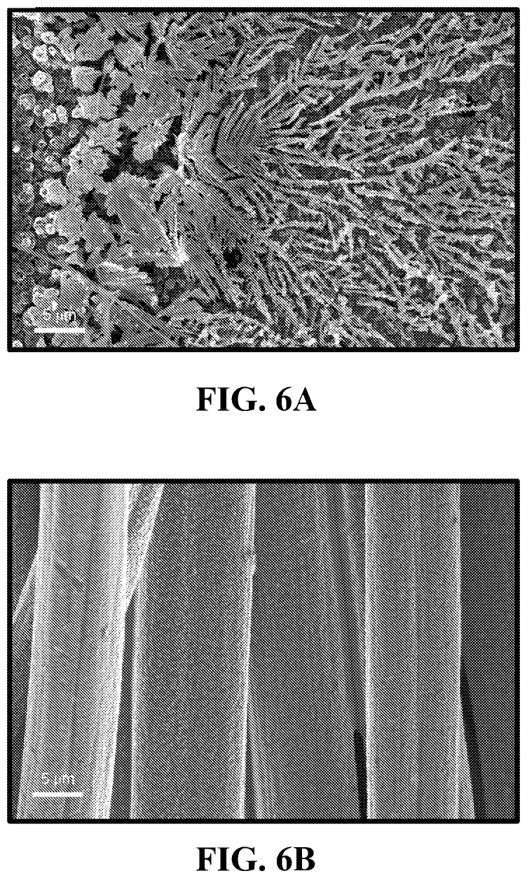

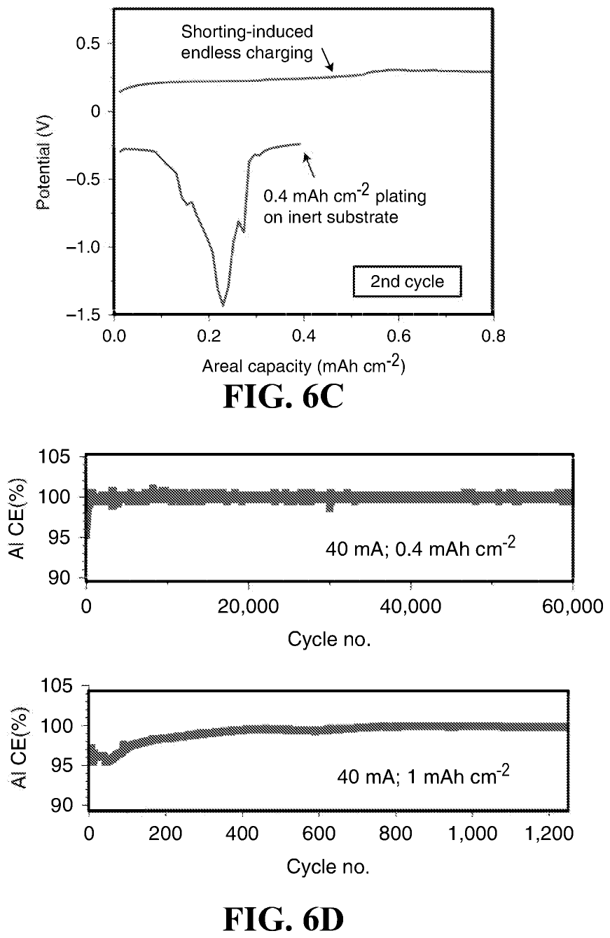

Present findings discussed in FIGS. 9A-9O would naturally lead to a question—if overpotential deposition can be used to achieve the same, perhaps even a more tunable effect on Al electrodeposit morphology than the effect produced by chemical bonding, why not use this effect instead? There are at least two problems. Firstly, electrochemical instability of electrolyte solvent, salt and other battery components at such large negative overpotentials would produce side reactions that reduce columbic efficiency and compromise long-term performance. Second, such large applied overpotential would drive the deposition of Al into the diffusion-limited regime, which could cause hydrodynamic instability and dendritic deposition (e.g. see also FIGS. 6A-6D for another example of DLI dendrites).

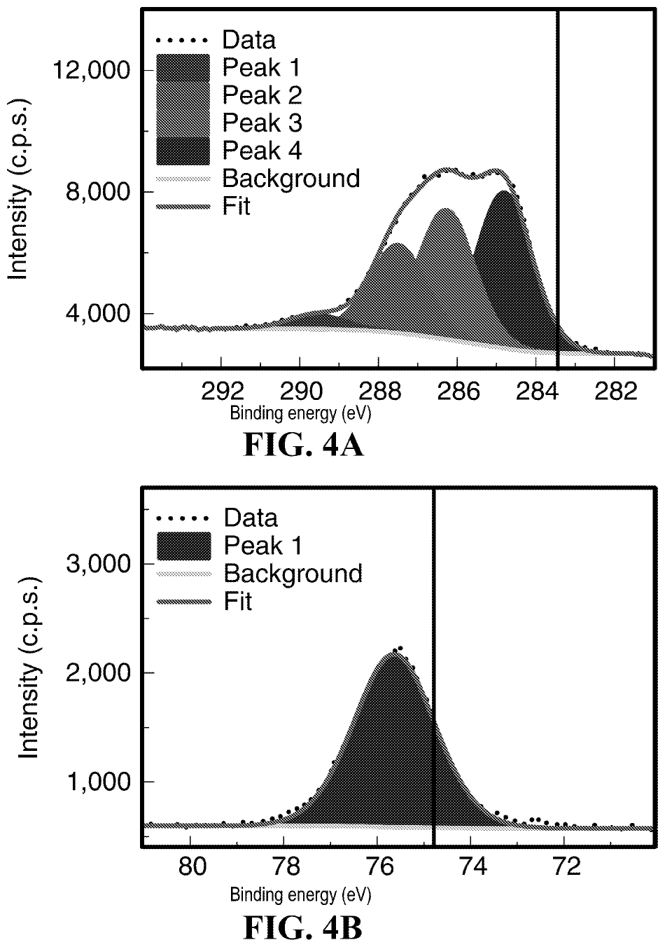

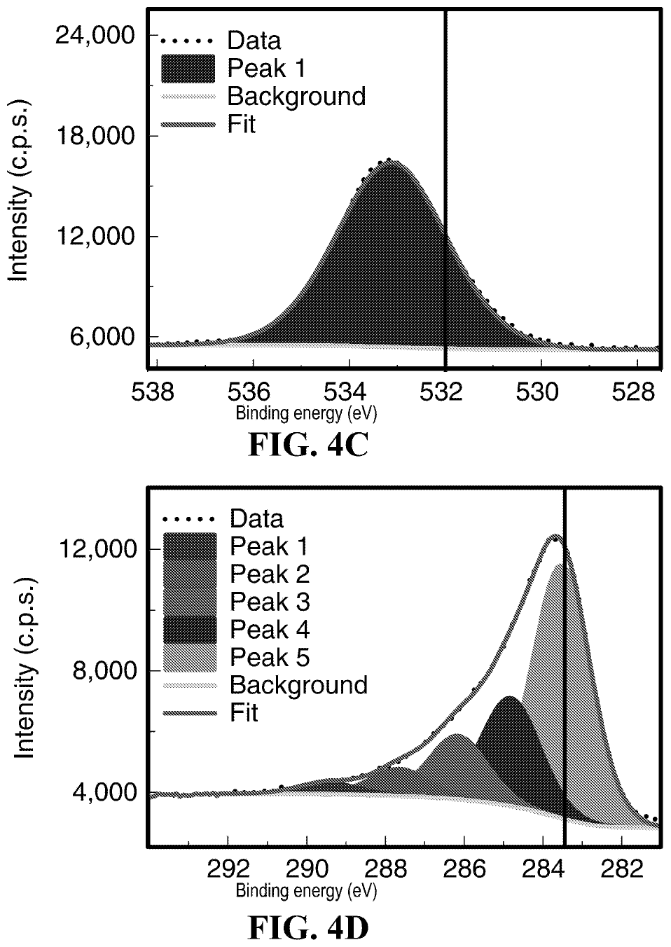

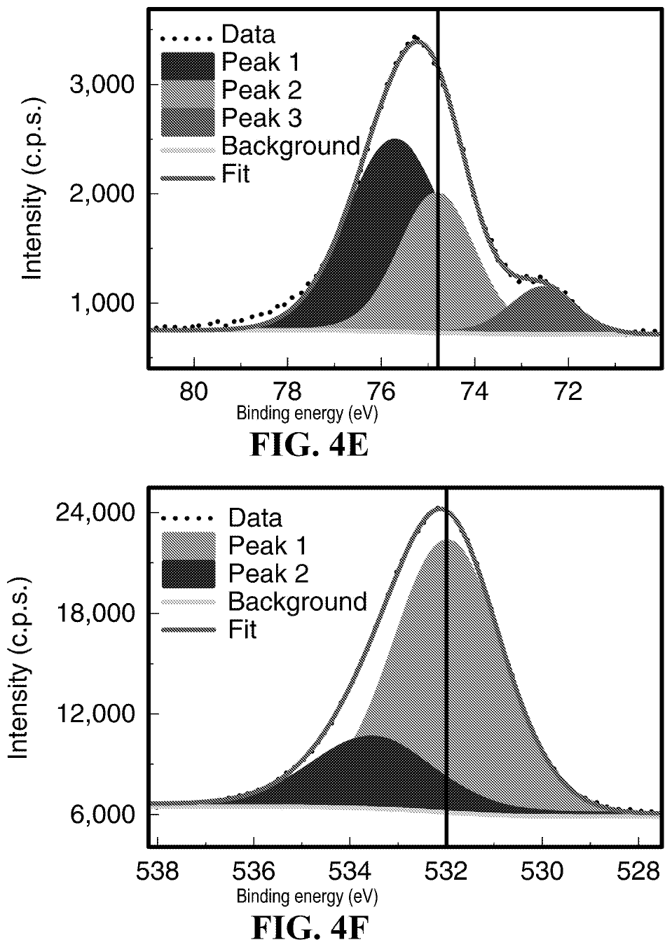

To more thoroughly interrogate the nature of the metal-substrate bonding, X-ray photo electron spectroscopy was performed. FIGS. 4A-4C show the XPS results of the as-deposited sample (3 mAh/cm²), which are consistent with the conclusion that no possible metal-substrate bonding is detected on the surface. This observation is expected since the substrate architecture is fully covered by the compact deposition layer, meaning that the metal-substrate interface is not exposed. FIGS. 4D-4F shows the XPS results of the sample after Art sputtering, during which the material on the sample surface is etched away. In this case, obvious new peaks emerge (C 1s: 283.5 eV; Al 2p: 74.7˜74.9 eV; O: 531.9 eV), which are ascribed to Al—O—C bonding. Table 3 shows C 1s, O 1s, and Al 2p XPS peak assignments for as deposited Al on C fiber and deposited Al on C fiber after 45 min. of Art ion sputtering.

TABLE 3

| Sample | As deposited Al on C fiber | After 45 min. Ar⁺ ion sputtering | |
|---|---|---|---|
| XPS Fit | BE (FWHM) area (rel. %) | BE (FWHM) area | Chemistry |
| C 1s | | 283.5 (1.73) 1.5 × 10⁴ (55) | Al—O—C |
| | 284.8 (1.65) 9.2 × 10³ (40) | 284.8 (1.73) 6.7 × 10³ (23) | C—C, C—H |
| | 286.3 (1.65) 7.6 × 10³ (33) | 286.1 (1.73) 3.9 × 10³ (14) | C—O |
| | 287.5 (1.65) 5.2 × 10³ (23) | 287.6 (1.73) 1.6 × 10³ (6) | O—C—O, C═O |
| | 289.6 (1.65) 8.5 × 10² (4) | 289.5 (1.73) 7.3 × 10² (3) | O═C—O |
| O 1s | | 531.9 (2.62) 4.5 × 10⁴ (78) | Al—O—C |
| | 533.1 (2.70) 3.2 × 10⁴ (100) | 533.4 (2.90) 1.3 × 10⁴ (22) | C—O, C═O |
| Al 2p | | 72.5 (1.6) 7.2 × 10² (9) | Al—Al |
| | | 74.8 (1.84) 2.5 × 10³ (32) | Al—O—C |
| | 75.6 (2.03) 3.5 × 10³ (100) | 75.7 (2.11) 4.5 × 10³ (59) | Al—Cl |

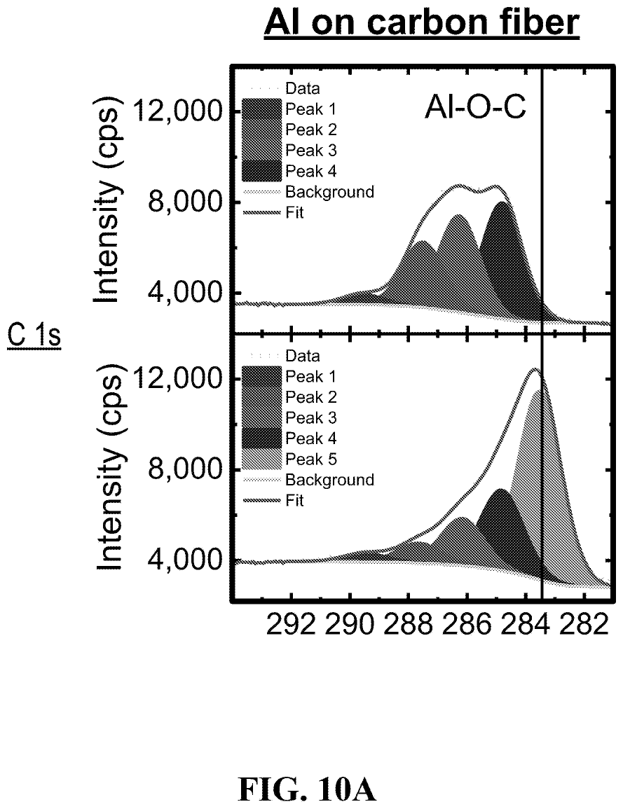

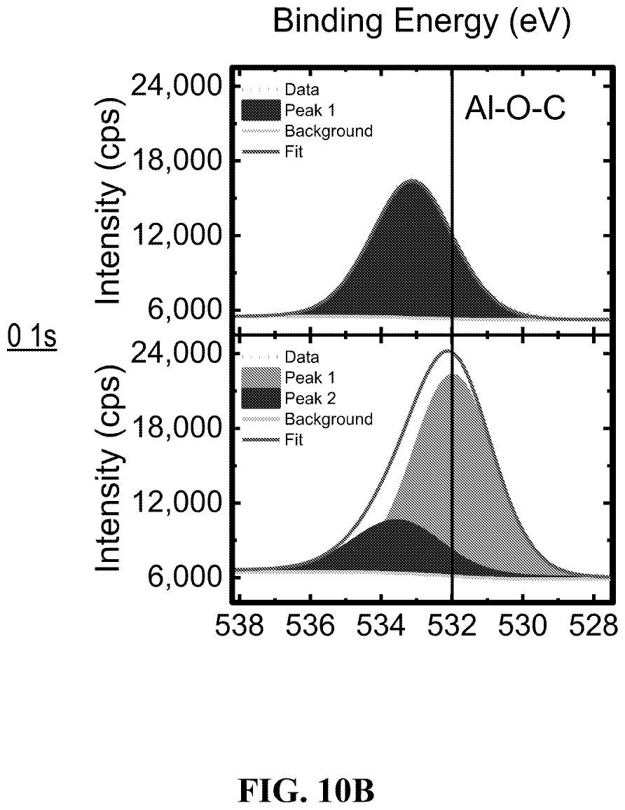

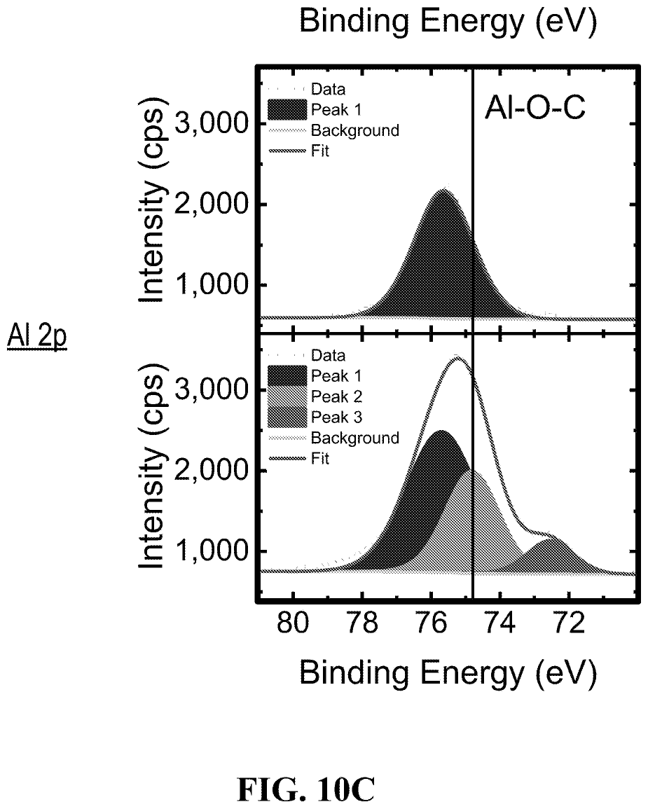

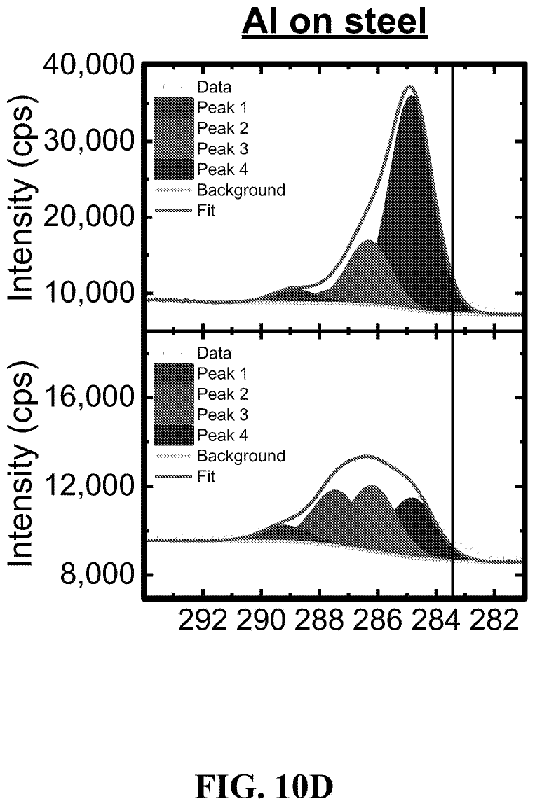

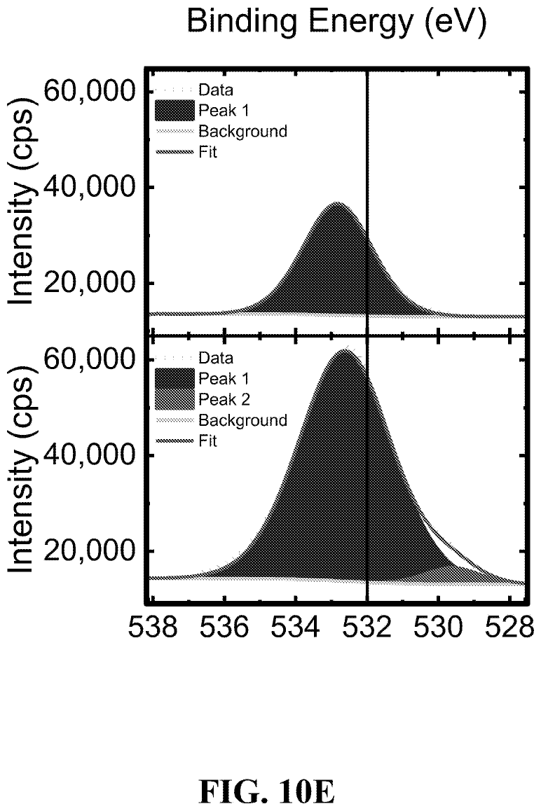

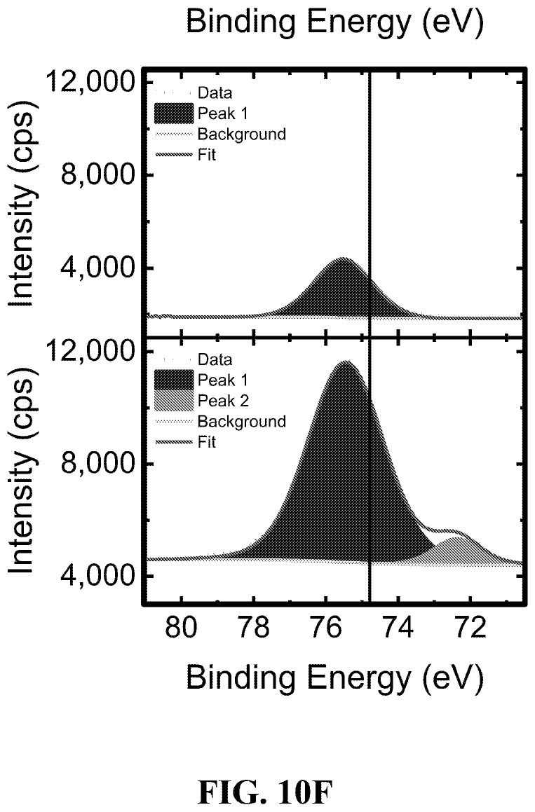

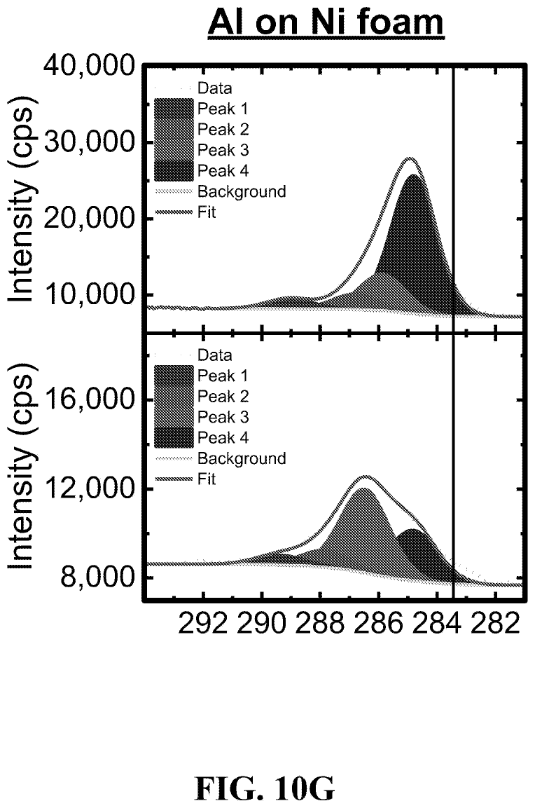

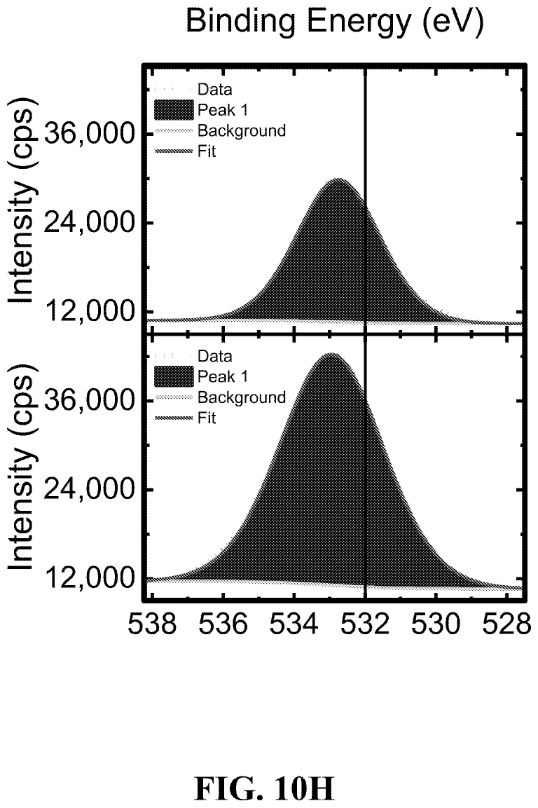

The C 1s spectra for the as deposited Al on carbon fiber sample shows peaks assigned to C—C and C—H (284.8 eV), C—O (286.3 eV), O—C—O and C═O (287.5 eV), and O═C—O (289.6 eV) bonds on the surface of the carbon fiber, suggesting oxidized surface character. The O Is shows a broad peak centered at 533.1 eV assigned to overlapping C—O type bonds, while the Al 2p peak at 75.6 eV is assigned to AlCl₃ from residual electrolyte salt on the sample. After Ar+ ion sputtering, a new peak at lower binding energy (283.5 eV) is observed in the C Is spectra and is assigned to Al—O—C. Related peaks in the O 1s spectra (531.9 eV) and Al 2p spectra (74.8 eV) corresponding to the Al—O—C species are also observed. A third distinct peak in the Al 2p spectra at 72.5 eV, attributed to Al—Al bonding, is also present. These observations are consistent with previous work. The metal-substrate bonding is also evidently mediated by the surface oxidation species of the carbon. In contrast, XPS measurements of Al electrodeposits on control substrates suggest that the Al—O—C bonding and other metal-substrate bonding do not exist on stainless steel and nickel foam (FIGS. 10A-10I).

Electrochemical Performance of Regulated Metal Anodes. To evaluate the reversibility of the Al deposited at these high areal capacities, the plating/stripping Coulombic efficiency (CE) of the Al electrodes in electrochemical cells was measured. The

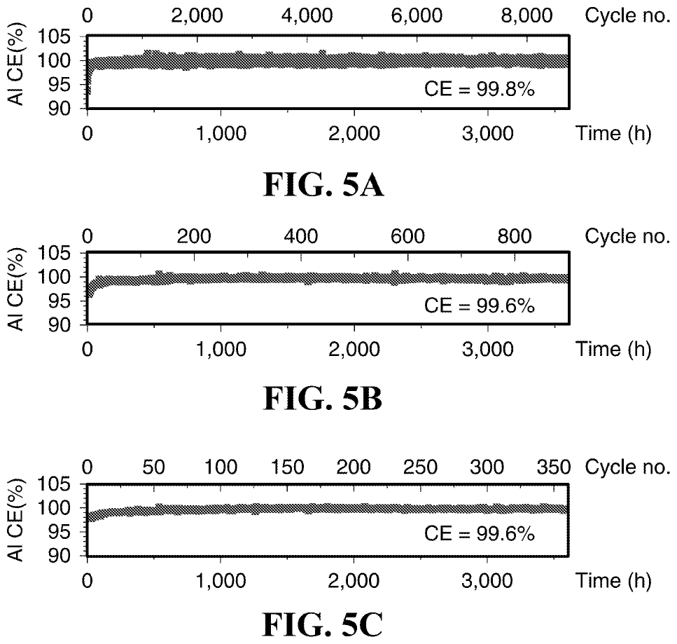

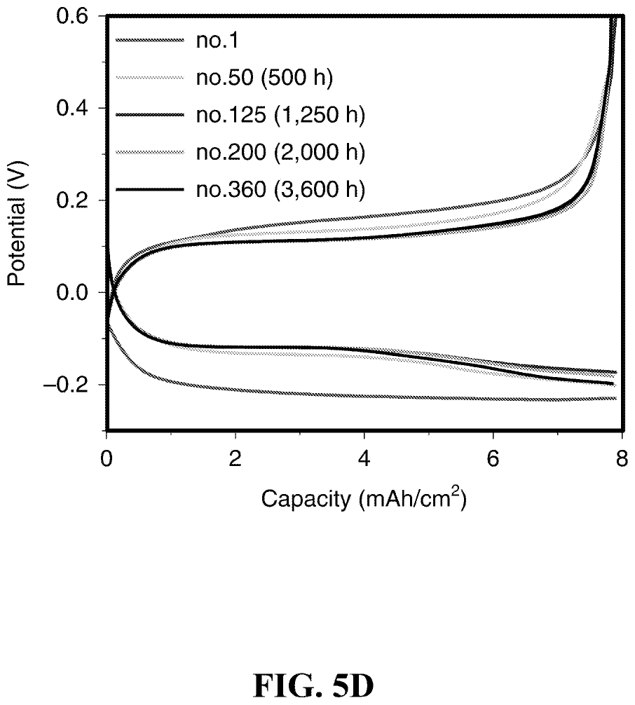

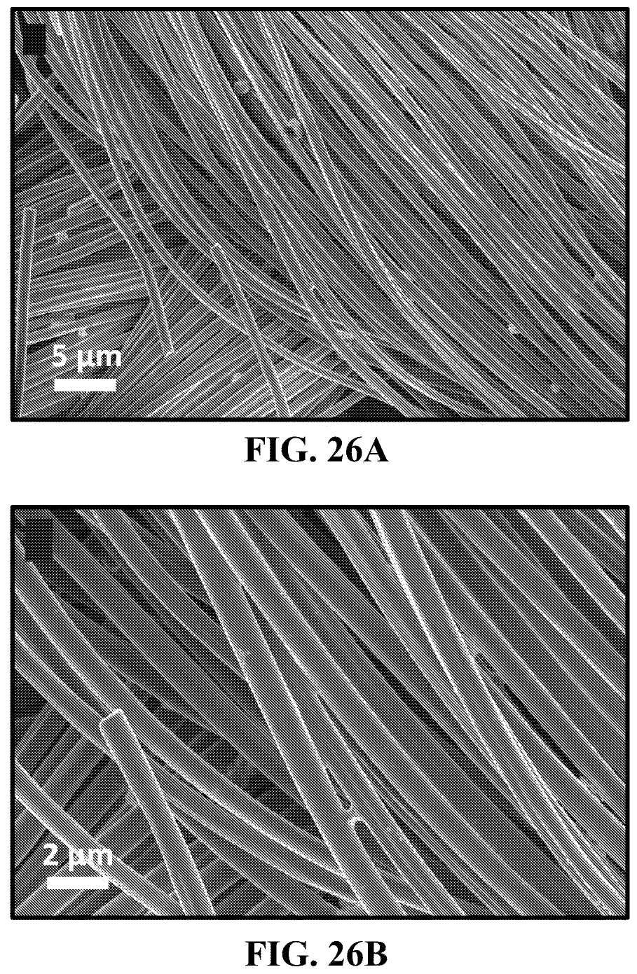

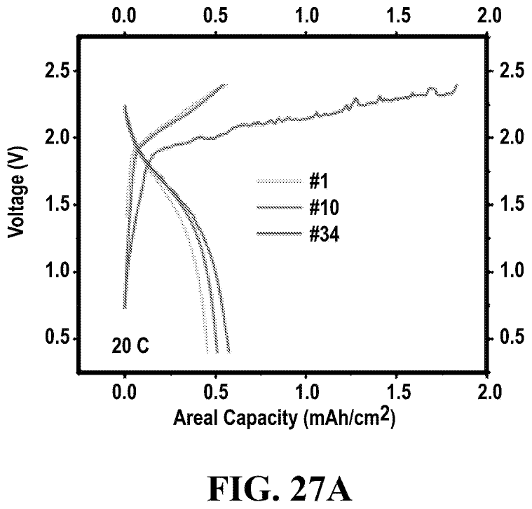

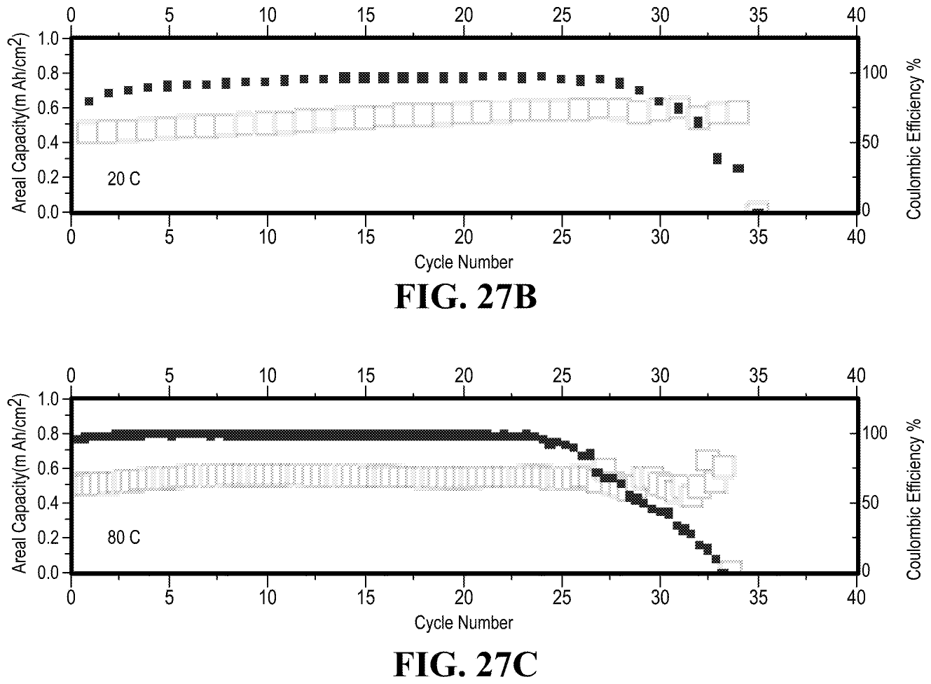

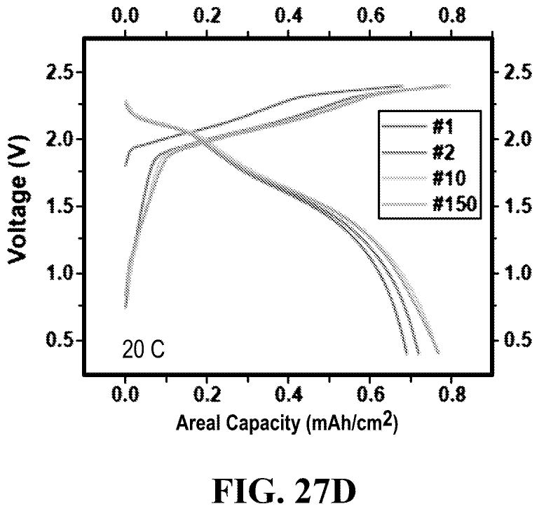

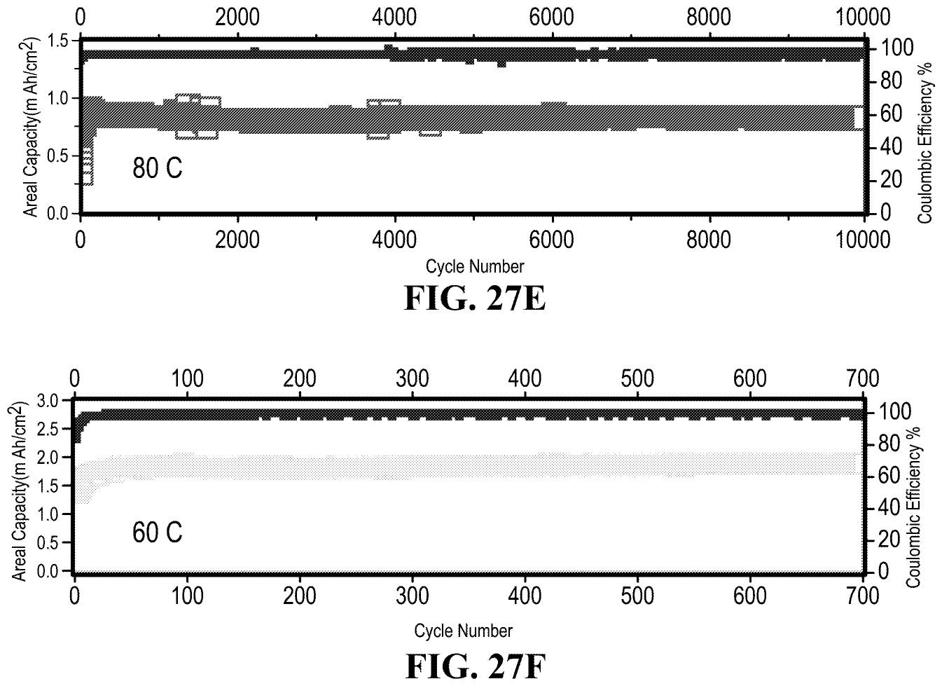

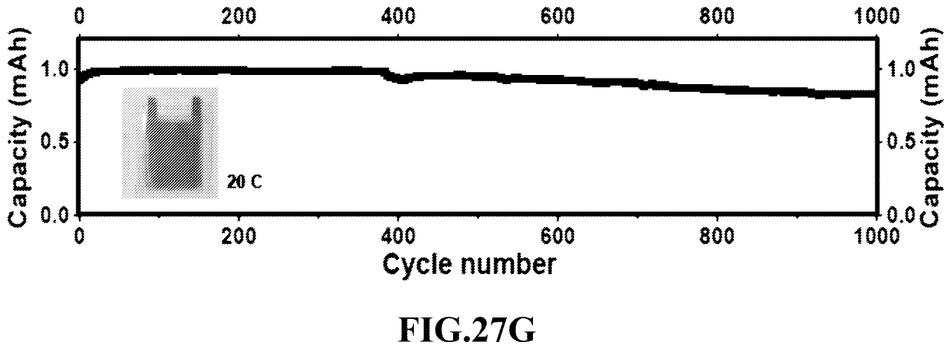

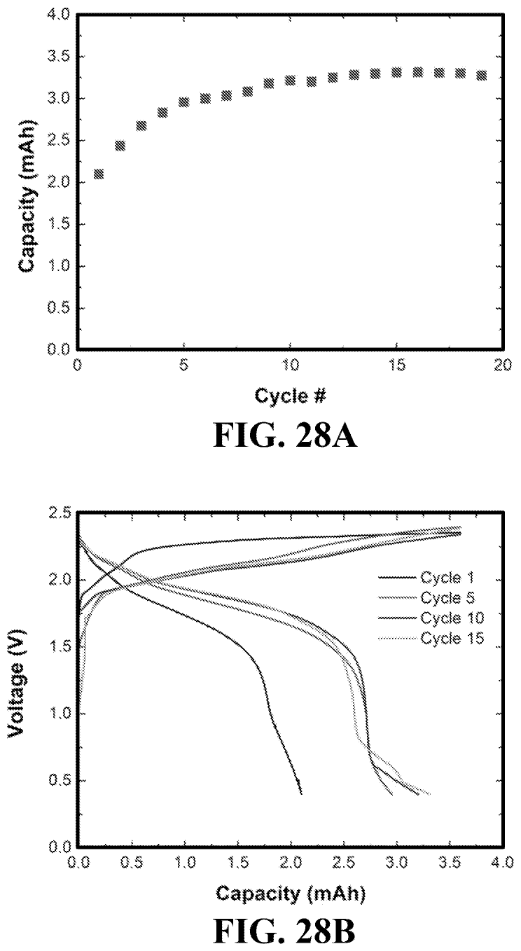

CE reveals the ratio between the amount of metal that can be stripped and the amount that is originally plated. The results are reported in FIGS. 5A-5D. In stark contrast to the low CE and rapid battery failure observed on a planar stainless steel substrate, anodes produced by Al electrodeposition in a patterned substrate composed of carbon fibers manifests a high level of reversibility (99.4%˜99.8%, stripped morphology in FIGS. 26A-26B) over a broad range of capacities (0.8˜8 mAh/cm²). The results also show that the cells maintain stable operations for more than 2000 hours (FIGS. 5A-5C). The voltage profile in FIG. 5D confirms that the plating/stripping reaction is stable, as evidenced by the narrowing overpotential over the 3600 hours of cycling, not showing any trend toward deterioration. It is also noteworthy that the CE at 8 mAh/cm² is not compromised by the presence of microscale Al deposits, owing to what is suspected to be the robust, interconnecting electronic pathway in the conductive nonplanar architecture that guarantees good electrochemical access to the metal and prevents formation of “dead” or “orphaned” Al. When paired with a cathode, this improvement can be clearly reflected in proof-of-concept full cells at elevated capacity ˜1 mAh/cm², which is 1 to 2 orders of magnitudes higher than the values reported in the literature (FIGS. 27A-27G, FIGS. 28A-28B). Consistent with the plating/stripping measurement, batteries using Al foil as the anode fail rapidly in less than 100 cycles. By contrast, “anode-free” full batteries with carbon-fiber anode without any pre-stored Al show stable cycling and excellent capacity retention over thousands of cycles. These results of full battery tests further confirm the high reversibility of Al plating/stripping on carbon fibers when subject to cycling.

As an extreme test of the approach, plating/stripping experiments were performed at an unprecedentedly high current density, i.e., 40 mA/cm². SEM characterization reveals that, diffusion limited ramified electrodeposit structures with classical fractal/dendritic morphologies are formed on the planar electrode (FIG. 6A). In contrast, nanoscale, compact Al electrodeposition is maintained on the carbon-based fibers (FIG. 6B).

As expected, the cells using the planar stainless steel foil, fail quickly by the short-circuiting process after less than 5 minutes (FIG. 6C). This can be compared with the electrochemical results in FIG. 6D, which show that high levels of reversibility and long lifetime (e.g., CE=99.96% and over 60000 cycles) with the regulation produced by the metal-substrate bonding.

The stable plating/stripping behaviors of Al under the regulation of metal-substrate bonding can be understood in a quantitative manner. As Al forms a compact layer on the surface of the carbon fibers, the electron transport length scale is maintained small. As a quantitative estimation, the characteristic relaxation time r of the nanoscale Al deposits formed in the patterned substrate is 4 orders of magnitudes smaller than that of the dendritic Al (L≈160 nm v.s. 20 μm) formed in the planar case. It means that the nanoscale Al can be stripped in a significantly faster manner. In addition to considerations based on transport, the non-planar/dendritic metal deposit is associated with a stronger morphological instability—as stripping occurs at the bottom of the deposits, the whole structure detaches from the electrode. Present observations therefore suggest that an Al anode in which the metal is deposited in a patterned substrate capable of forming strong bonds with Al are of potential immediate interest for applications in Al batteries operating under various conditions. The electrochemical performance achieved for presently disclosed Al anodes (Table 2) has been compared with those of state-of-the-art commercial Li-ion technology. It is apparent that even without taking into accounts the intrinsic advantages of Al metal including safety, cost, ease of manufacturing, and high earth-crust abundance, Al batteries based on the anode design disclosed herein show significant promise.

To explore the broader utility of this concept, the electrodeposition of Zn,

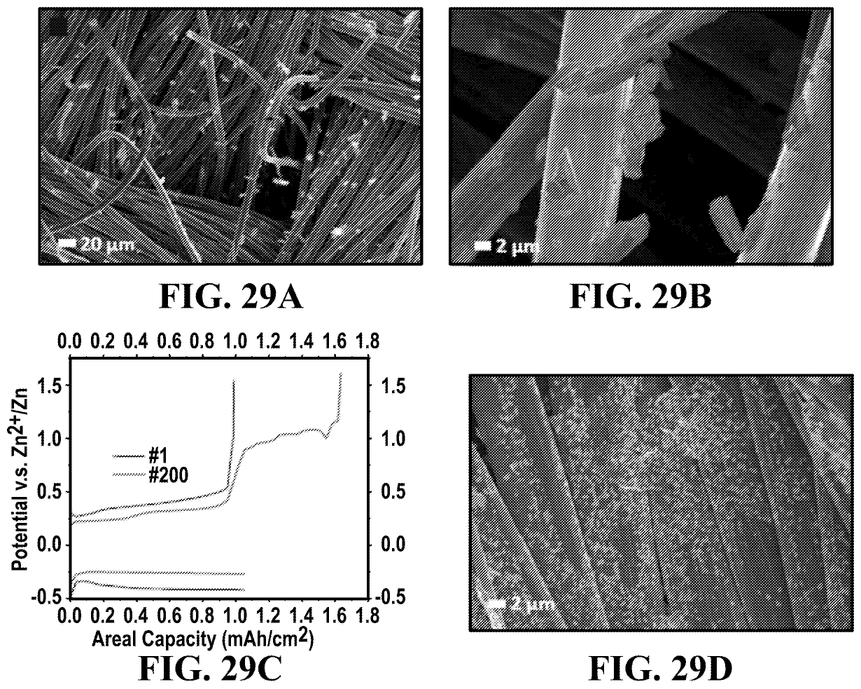

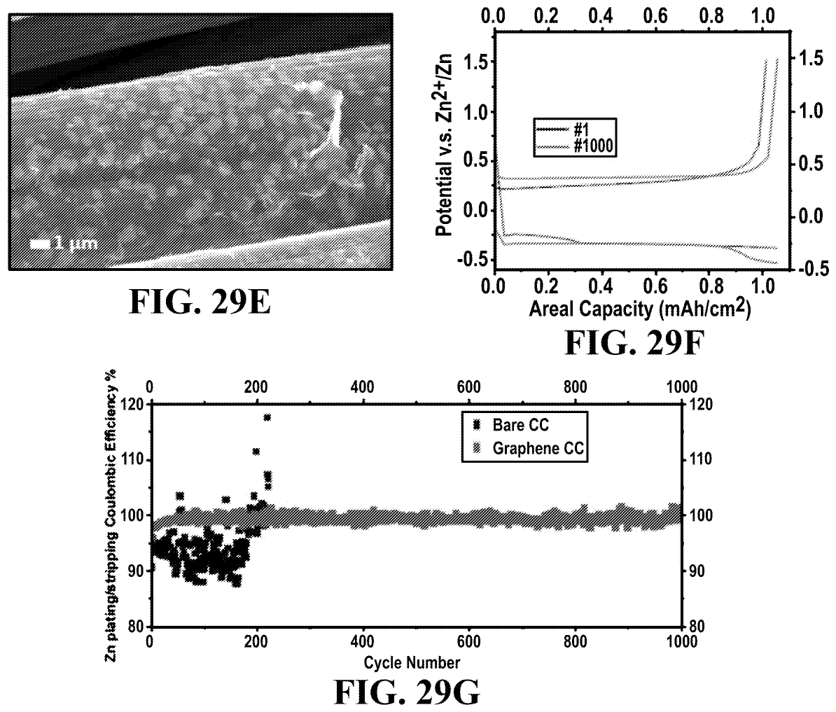

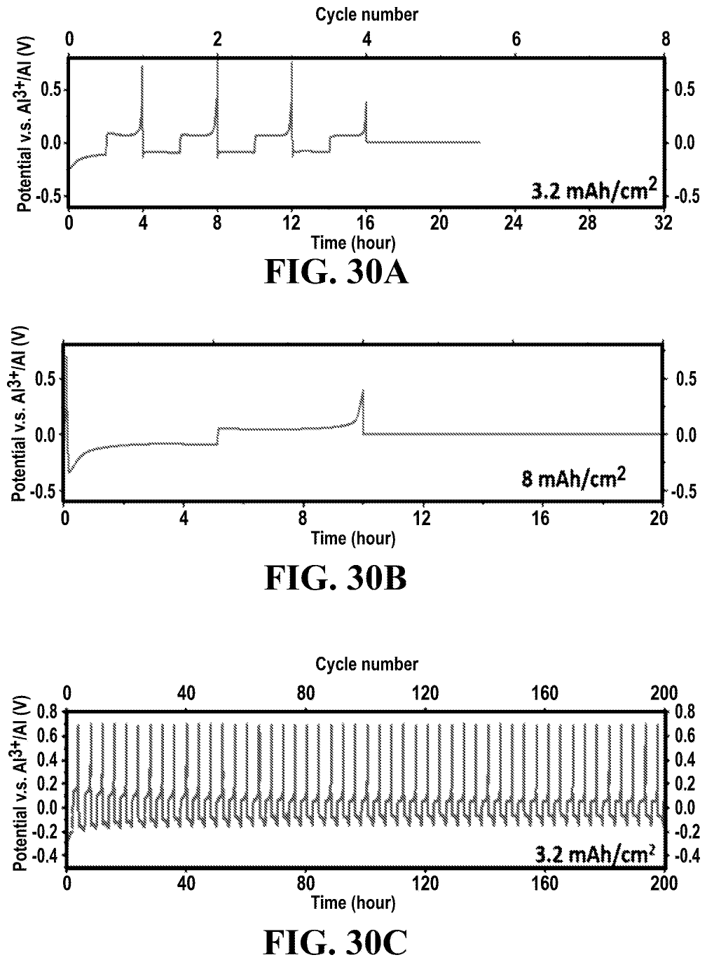

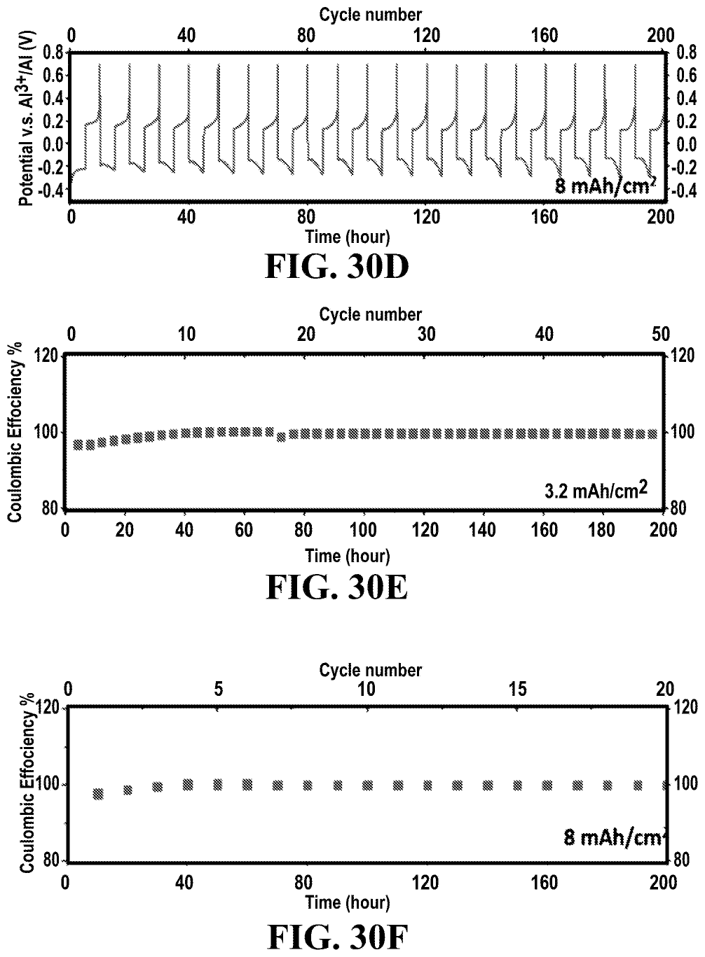

another metallic battery anode material arousing enormous research interest recently, was studied in a patterned substrate composed of interwoven carbon fibers (FIGS. 29A-29G). The galvanostatic plating/stripping results demonstrate that, unlike Al, Zn has a low plating/stripping efficiency and slow kinetics on carbon fibers; indicating that the substrate architecture alone is insufficient for achieving highly reversible deposition. A strong metal-substrate interaction was artificially introduced by coating the substrate with graphene, which has been recently reported to strongly coordinate with Zn by an epitaxial mechanism owing to a minimized interfacial energy. In stark contrast, the plating/stripping reversibility and lifetime are significantly improved. SEM results show that, the presence of the strong metal-substrate interaction via the graphene interphase can effectively promote the uniform deposition of nanoscale, plate-like Zn metal that shows a minimized electron transport length scale, in comparison with the microscale Zn deposits observed on bare carbon fibers (FIGS. 29A-29G). Moreover, the effectiveness of metal-substrate bonding can be demonstrated on planar substrates, which is a more conventional configuration in commercial batteries. The electrochemical plating/stripping of Al on stainless steel coated by carbon nanotubes with and without carboxylic side groups was evaluated. As shown in FIGS. 30A-30F, the planar substrates coated with carboxylic-functionalized carbon nanotubes manifest stable cycling and high Coulombic efficiency, in comparison with bare stainless steel and even nonplanar nickel foam. On this basis, it was concluded that the concept to regulate electrodeposition morphology can be readily extended to other electrodeposition systems of different chemistries or geometries by rationally designing an artificial metal-substrate interphase that provides strong interactions.

In summary, specific interfacial metal-substrate bonding is described in this Example can be used to achieve fine control of metal electrodeposit morphology and uniform, compact, and exceptionally reversible metal deposition. Using metallic aluminum as an example, it was shown for the first time how such bonds can be used to overcome the metal's natural affinity for the separator and to prevent aggressive, non-planar electrodeposition. Extension of the concept to create patterned Al anodes, reveals that it is possible to achieve highly reversible metal anodes with combinations of areal specific capacity and cycle life that are one or more orders of magnitude higher than previous literature reports. Findings confirm that the reversibility of metal anodes requires continuous access to ionic and electronic transport pathways in the electrode and is strongly correlated with control of the electron transport length scale. Based on successful extension to Zn metal anodes, it is expected that the concept can be generalized to achieve desirable reversibility in other metallic anodes in batteries.

Methods. Materials. 1-Ethyl-3-methylimidazolium chloride ([EMIm]CI, 98%), AlCl₃ (99.99%), Whatman glass fiber filters (GF/B), 0.25 mm Zn foil (99.9%), carboxymethyl cellulose (CMC) and ZnSO₄.7H₂O were purchased from Sigma Aldrich. 0.25 mm-thick aluminum foil (99.99%), 0.127 mm-thick tantalum foil were bought from Alfa Aesar. Nickel foam was manufactured by MTI. Stainless steel 304 was used as a conventional, planar substrate for electrodeposition. Deionized water was obtained from Milli-Q water purification system. Graphene dispersion in N-Methyl-2-Pyrrolidone (4 wt %), few-layer graphene dispersion in water (4 wt %), carboxylic functionalized carbon nanotubes, graphitized carbon nanotubes were purchased from ACS Material. Free-standing interwoven carbon fibers (Plain carbon cloth 1071 HCB) was purchased from Fuel Cell Store.

Preparation of electrolytes. Al anode electrolyte: In an Ar-filled glovebox (less than 0.1 ppm H₂O, less than 1 ppm O₂), AlCl₃ powder was added slowly into [EMIm]Cl in a glass vial with 500 rpm stirring to form a yellowish liquid electrolyte. The molar ratio is IL: AlCl₃=1:1.3, which results in a Lewis-acidic electrolyte where reversible Al plating/stripping is possible. Al foil was placed in the as-prepared IL-AlCl₃ electrolyte to remove impurities such as hydrochloric acid in the electrolyte. After resting for 7 days, the electrolyte turned colorless and was used as electrolyte for Al cells. Zn anode electrolyte: ZnSO₄.7H₂O was slowly dissolved into the deionized water in a glass vial to prepare the 2M ZnSO₄ electrolyte for Zn cells. The transparent, clear electrolyte was rested for 1 day before use

Characterization of materials. Field-emission scanning electron microscopy (FESEM) was carried out on Zeiss Gemini 500 Scanning Electron Microscope equipped with Bruker energy dispersive spectroscopy (EDS) detector to study the electroplate/strip morphology. An accelerating voltage of 5 kV was used for imaging, and 10 kV was used for EDS measurement. 2D-XRD was performed on Bruker D8 General Area Detector Diffraction System with a Cu Kα X-ray source. The incident beam angle and the detector angle are both set at 18 degrees. Raman spectroscopy was performed on an Renishaw InVia Confocal Raman microscope using 785 nm laser. X-ray photon electron spectroscopy (XPS) experiments were carried out in a UHV chamber equipped with SPECS Phoibos 100 MCD analyzer. A non-monochromatized Al-Kα (hv=1486.6 eV) X-ray source was used for the analysis. The accelerating voltage was 15 kV and the current was 20 mA. The chamber had a base pressure of 2×10⁻⁹ Torr. Electrodes were pressed onto a conductive copper tape and mounted on the sample holder. Charge correction for the data was done to by adjusting the C 1s binding energy to 284.8 eV for C—C and C—H bonds. The XPS analysis regions measured were 65-90 eV for Al 2p, 520-545 eV for O 1s, and 265-300 eV for C 1s. Epass of 20, step size of 0.05 eV and scan number of 10 were applied to measure each individual region. Ar sputtering was performed at room temperature with a pressure of 2×10⁻⁵ Torr using an energy of 1.5 keV.

Electrochemical measurements. Galvanostatic plating/stripping performance of metals in coin-type electrochemical cells (CR2032) were tested on Neware battery test systems at room temperature. The diameter of electrodes in the plating/stripping measurements was ½ inch. Electrodes are separated by one layer of glass fiber (GF/B, Whatman), unless otherwise specified. Stainless steel and carbon cloth were washed by ultrasonication in deionized water and acetone. In each coil cell, ˜120 μL electrolyte was added by pipette to make sure the electrodes and the separator are wetted.

In Al metal plating/stripping Coulombic efficiency measurements, the electrochemical cells have two electrodes: Al source electrode and substrate electrode (e.g. Al∥stainless steel, Al∥carbon fibers, etc.). In the measurement, a certain amount of Al is plated on the substrate electrode of interest, and a reverse potential is applied to strip the deposited Al metal back to the Al source electrode.

$$Coulombic efficiency ( CE ) = \frac{stripping capacity}{plating capacity on the substrate} \times 100 \% .$$

In the Al∥stainless steel cells, commercial Al foil was used as the Al source. In the Al∥carbon fiber cells, Al electrodeposited on carbon fiber was used as the Al source because the battery short is caused by uncontrollable Al growth during both the plating on the substrate electrode, and on the Al source electrode. As a result, both of the two electrodes need to be carbon fibers, in order to measure the true stabilizing effect of using carbon fibers as deposition substrate.

Full cells were assembled to further evaluate Al plating/stripping behavior in the anode. In “anode-free” full cells constructed using carbon fibers, no Al metal was prestored in the anode. It means that Al metal solely comes from battery charging: 4Al₂Cl₇⁻+3e⁻→Al(s)+7AlCl₄⁻. To offset the initial capacity loss possibly owing to side reactions as can be seen in FIGS. 5 and 6, carbon fiber electrodes were subject to a formation process: Al was plated and striped on carbon fibers at 40 mA/cm²-0.4mAh/cm² for 50 cycles. After the formation process, the carbon fiber electrode was charged to 0.7 V v.s. Al³⁺/Al to fully remove any electrochemically active Al metal, and was harvested for the subsequent assembly of full cells. In control full cells, commercial 0.25 mm-thick Al foil was used as the anode. It means that a large amount of extra Al metal is prestored in the anode, as can be quantified by an N:P ratio of 100:1 (70 mAh/cm² anode:0.7 mAh/cm² cathode). The graphite-based cathodes offering high areal capacity were designed according to principles and methods discussed in a prior study. Nonplanar, interwoven carbon fiber electrodes were used as matrix to ensure fast transport and the physical integrity of the thick, high areal capacity cathodes. Carboxymethyl cellulose (CMC) was added into a water dispersion of few-layer graphene, forming a viscoelastic fluid. A strain was applied to periodically agitate the fluid in order to drive the active materials into the porous medium, i.e. the interwoven carbon fibers. The graphene-infused carbon fiber electrodes (¼ inch diameter) were dried at 60° C. overnight in an oven. Tantalum foils were used as the spacer to prevent possible corrosion in the cathode.

Although the present disclosure has been described with respect to one or more particular embodiments and/or examples, it will be understood that other embodiments and/or examples of the present disclosure may be made without departing from the scope of the present disclosure.

1. An anode material comprising:
an electrically conducting three-dimensional (3-D) matrix, and
a plurality of chemical bonding groups,
wherein each of the plurality of chemical bonding groups are chemically bonded to a surface of the electrically conducting 3-D matrix.

2. The anode material of claim 1, wherein the electrically conducting 3-D matrix is chosen from electrically conducting 3-D carbon matrixes and metal foams.

3. The anode material of claim 2, wherein the electrically conducting 3-D carbon matrix(es) is/are chosen from carbon, carbon fabrics, carbon cloths, graphene aerogels, carbon nanotubes, vapor grown carbon fibers, activated carbon fibers, oxygen enriched derivatives thereof, and any combination thereof.

4. The anode material of claim 1, wherein the electrically conducting 3-D matrix comprises a plurality of porous regions.

5. The anode material of claim 4, wherein the porous regions are at least partially continuous.

6. The anode material of claim 4, wherein the porous regions comprise one or more or all dimensions of 100 nm to 200 microns.

7. The anode material of claim 4, wherein the porous regions comprise 30% or more of the total volume of the electrically conducting 3-D matrix.

8. The anode material of claim 1, wherein the chemical bonding groups are chosen from halide groups, hydroxyl groups, carboxyl/carboxylate groups, sulfo groups, phosphonate groups, alkenyl groups, alkynyl groups, and any combination thereof.

9. The anode material of claim 1, wherein at least a portion of the chemical bonding groups are bound to a surface of electrically conducting 3-D matrix via a linking group.

10. The anode material of claim 9, wherein the linking group comprises a metal.

11. The anode material of claim 10, wherein the linking group is —O-M-, wherein M is a metal chosen from aluminum, zinc, lithium, sodium, calcium, magnesium, and any combination thereof.

12. The anode material of claim 1, wherein at least a portion of the chemical bonding groups are provided by a material disposed on at least a portion of a surface of the electrically conducting 3-D matrix, wherein the material comprises the at least a portion of the chemical bonding groups.

13. The anode material of claim 12, wherein the material is chosen from graphene, carbon nanotubes, ketjen black carbon, vapor grown carbon fibers, pyrolyzed carbon fibers, oxygen-enriched derivatives thereof, and any combination thereof.

14. The anode material of claim 13, wherein the chemical bonding groups are disposed on at least 25% of the exterior surfaces of the electrically conducting 3-D matrix.

15. The anode material of claim 1, wherein the number density of the chemical bonding groups is 0.01/nm² to 10/nm².

16. The anode material of claim 1, wherein the electrically conducting 3-D matrix has a conductivity of 1 to 10⁸ S/m.

17. The anode material of claim 1, wherein the electrically conducting 3-D matrix is disposed on a metal.

18. An anode comprising one or more anode material(s) of claim 1.

19. The anode of claim 18, the anode further comprising a layer of an electrochemically active metal disposed on at least a portion or all of one or more surface(s) of the electrically conducting 3-D matrixes.

20. The anode of claim 19, wherein the electrochemically active metal is chosen from aluminum, zinc, lithium, sodium, calcium, magnesium, and any combination thereof.

21. The anode of claim 19, wherein the layer of the electrochemically active metal has a thickness of 10 nm to 1 mm.

22. The anode of claim 19, wherein the number density of the chemical bonds between the electrically conducting 3-D matrix and layer of the electrochemically active metal is from 0.01/nm² to 10/nm².

23. The anode of claim 19, wherein the layer of the electrochemically active metal is continuous over 50% or greater of one or more surface(s) of the electrically conducting 3-D matrix.

24. The anode of claim 19, wherein there are no observable discontinuities in the layer of the electrochemically active metal over 50% or greater of the one or more surface(s) of the electrically conducting 3-D matrix.

25. The anode of claim 19, wherein the layer of the electrochemically active metal does not exhibit an isolated electrochemically active metal deposit or an isolated electrochemically active metal.

26. The anode of claim 19, wherein the layer of electrochemically active metal is chemically bonded to the electrically conducting 3-D matrix(es) via a plurality of chemical bonds.

27. The anode of claim 26, wherein the chemical bonds are covalent bonds, coordinate covalent bonds, ionic bonds, or any combination thereof.

28. The anode of claim 26, wherein the layer of electrochemically active metal is formed from reaction of a chemical bonding group with an electrochemically active metal, electrochemically active metal atom(s), or electrochemically active metal atom cluster(s), or any combination thereof.

29. The anode of claim 18, wherein the anode is a reversible anode.

30. A method of making an electrode material of claim 1 comprising:
i) functionalizing an electrically conducting 3-D matrix, or
ii) providing an electrically conducting 3-D matrix comprising a plurality of first chemical bonding groups chemically bonded to a surface of the electrically conducting 3-D matrix, wherein each of the plurality of chemical bonding groups are chemically bonded to a surface of the electrically conducting 3-D matrix, and
functionalizing the electrically conducting 3-D matrix comprising a plurality of first chemical bonding groups, with a material comprising a plurality of second chemical bonding groups,
wherein the electrode material of claim 1 is formed.

31. The method of claim 30, wherein the functionalizing results in formation of a plurality of first functional groups and the first functional groups are subjected to conditions such that at least a portion of the first functional groups is reacted to form a plurality of second functional groups, wherein the second functional groups are chemical bonding groups.

32. The method of claim 30, wherein the functionalizing comprises contacting the electrically conducting 3-D matrix with a composition that forms the chemical bonding groups.

33. The method of claim 30, wherein the functionalizing comprises forming a graphene layer on at least a portion of an exterior surface of the electrically conducting 3-D matrix.

34. The method of claim 30, the method further comprising electrochemically depositing a layer of an electrochemically active metal on at least a portion of a surface of the electrically conducting 3-D matrix comprising a plurality of chemical bonding groups.

35. The method of claim 34, wherein the electrochemical deposition is carried out in a device.

36. A device comprising one or more anode(s) of claim 30.

37. The device of claim 36, wherein the device is an electrochemical device.

38. The device of claim 36, wherein the electrochemical device is a battery, a supercapacitor, a fuel cell, an electrolyzer, or an electrolytic cell.

39. The device of claim 38, wherein the battery is an ion-conducting battery.

40. The device of claim 39, wherein the ion-conducting battery is an aluminum-ion conducting battery, a zinc-ion conducting battery, a lithium-ion conducting battery, a sodium-ion conducting battery, a calcium-ion conducting battery, or a magnesium-ion conducting battery.

41. The device of claim 38, wherein the battery further comprises a cathode and/or one or more electrolyte(s) and/or one or more current collector(s) and/or one or more additional structural component(s).

42. The device of claim 41, wherein the one or more additional structural component(s) is/are chosen from bipolar plates, external packaging, electrical contacts/leads to connect wires, and any combination thereof.

43. The device of claim 38, wherein the battery comprises a plurality of cells, each cell comprising one or more anode(s), and optionally, one or more cathode(s), one or more electrolyte(s), one or more current collector(s), or any combination thereof.

44. The device of claim 43, wherein the battery comprises 1 to 500 cells.

45. The device of claim 38, wherein the device is a battery and the battery exhibits one or more or all of the following:
an areal capacity of at least 0.5 mAh/cm²;
a cycle life of at least 100 cycles;
an areal capacity of at least 0.4 or at least 1 mAh/cm² at a charging rate of 40 mA/cm² for at least 100 cycles;
a coulombic efficiency of 98% or greater.

46. The device of claim 36, wherein the device is configured such that the anode(s) is/are formed prior to the first bulk metal electrodeposition on the anode(s) during routine operation of the device.
